(19) United States
(12) Patent Application Publication
(10) Pub. No.: US 2017/0293818 A1
(43) Pub. Date: Oct. 12, 2017

(54) METHOD AND SYSTEM THAT DETERMINE THE SUITABILITY OF A DOCUMENT IMAGE FOR OPTICAL CHARACTER RECOGNITION AND OTHER IMAGE PROCESSING

(71) Applicant: ABBYY Development LLC, Moscow (RU)

(72) Inventors: Ivan Germanovich Zagaynov, Moscow Region (RU); Vasily Vasilievich Loginov, Moscow Region (RU); Nikita Konstantinovich Orlov, Chelyabinsk Region (RU)

(21) Appl. No.: 15/165,512

(22) Filed: May 26, 2016

(30) Foreign Application Priority Data
Apr. 12, 2016 (RU) 2016113867

(51) Int. Cl. G06K 9/18; G06K 9/48; G06T 5/40; G06T 7/00; G06T 5/30

(52) U.S. Cl. CPC G06K 9/18; G06T 7/0002; G06T 7/0053; G06T 7/0085; G06T 5/30; G06T 5/40; G06K 9/481; G06T 2207/30176; G06K 2009/485; G06K 2209/01

(57) ABSTRACT

The current document is directed to a computationally efficient method and system for assessing the suitability of a text-containing digital image for various types of computational image processing, including optical-character recognition. A text-containing digital image is evaluated by the disclosed methods and systems for sharpness or, in other words, for the absence of, or low levels of, noise, optical blur, and other defects and deficiencies. The sharpness-evaluation process uses computationally efficient steps, including convolution operations with small kernels to generate contour images and intensity-based evaluation of pixels within contour images for sharpness and proximity to intensity edges in order to estimate the sharpness of a text-containing digital image for image-processing purposes.

### CROSS REFERENCE TO RELATED APPLICATIONS

The present application claims the benefit of priority under 35 U.S. C. 119 to Russian Patent Application No. 2016113867, filed Apr. 12, 2016; the disclosure of which is herein incorporated by reference in its entirety for all purposes.

### TECHNICAL FIELD

The current disclosure is directed to image-processing methods and systems and, in particular, to an evaluation component of an imaging device or image-processing system that assesses the suitability of a document image for various types of image capture and image processing.

### BACKGROUND

Printed natural-language documents continue to represent a widely used communications medium among individuals, within organizations, and for distribution of information among information consumers. With the advent of ubiquitous and powerful computational resources, including personal computational resources embodied in smart phones, pads, tablets, laptops, and personal computers, as well as larger-scale computational resources embodied in cloud-computing facilities, data centers, and higher-end servers within various types of organizations and commercial entities, natural-language information is, with increasing frequency, encoded and exchanged in electronic documents. Printed documents are essentially images, while electronic documents contain sequences of numerical encodings of natural-language symbols and characters. Because electronic documents provide advantages in cost, transmission and distribution efficiencies, ease of editing and modification, and robust-storage over printed documents, an entire industry supporting methods and systems for transforming printed documents into electronic documents has developed over the past 50 years. Computational optical-character-recognition methods and systems and electronic scanners together provide reliable and cost-effective imaging of printed documents and computational processing of the resulting digital images of text-containing documents to generate electronic documents corresponding to the printed documents.

In the past, electronic scanners were large-size desktop, table top, and free-standing electronic appliances. However, with the advent of camera-containing smart phones and other mobile, processor-controlled imaging devices, digital images of text-containing documents can be generated by a large variety of different types of ubiquitous, hand-held devices, including smart phones, inexpensive digital cameras, inexpensive video surveillance cameras, and imaging devices included in mobile computational appliances, including tablets and laptops. Digital images of text-containing documents produced by these hand-held devices and appliances can then be processed, by computational optical-character-recognition systems, including optical-character-recognition applications in smart phones, to produce corresponding electronic documents.

Unfortunately, hand-held document imaging is associated with increased noise, optical blur, and other defects and deficiencies in the text-containing digital images produced by the hand-held devices and appliances in comparison with dedicated document-scanning appliances. These defects and deficiencies can seriously degrade the performance of computational optical-character recognition, greatly increasing the frequency of erroneous character recognition and failure of optical-character-recognition methods and systems to produce text encoding of all or large regions of digital text-containing images. Thus, while hand-held document-imaging devices and appliances have great advantages in cost and user accessibility, they are associated with disadvantages and drawbacks that can frustrate and prevent generation of electronic documents from digital text-containing images captured by hand-held devices and appliances. In many other situations, text-containing digital images have be associated with similar defects and deficiencies that can render the results of subsequently applied image-processing methods unsatisfactory. For this reason, designers and developers of imaging devices and appliances and optical-character-recognition methods and systems, as well as users of the devices, appliances, and optical-character-recognition systems, continue to seek methods and systems to ameliorate the defects and deficiencies inherent in many text-containing digital images, including mobile-device-captured digital text-containing digital images, that frustrate subsequent computational image processing of the text-containing digital images.

### SUMMARY

The current document is directed to a computationally efficient method and system for assessing the suitability of a text-containing digital image for various types of computational image processing, including optical-character recognition. A text-containing digital image is evaluated by the disclosed methods and systems for sharpness or, in other words, for the absence of, or low levels of, noise, optical blur, and other defects and deficiencies. The sharpness-evaluation process uses computationally efficient steps, including convolution operations with small kernels to generate contour images and intensity-based evaluation of pixels within contour images for sharpness and proximity to intensity edges in order to estimate the sharpness of a text-containing digital image for image-processing purposes. The disclosed methods and systems allow users to evaluate the suitability of text-containing digital images for image processing before expending the computational and temporal overheads associated with applying image-processing methods to the text-containing digital images, greatly increasing the probability that image processing generates error-free or low-error electronic documents from text-containing digital images.

### BRIEF DESCRIPTION OF THE DRAWINGS

FIG. 1A illustrates two different types of hand-held imaging devices.

FIG. 1B illustrates two different types of hand-held imaging devices.

FIG. 1C illustrates two different types of hand-held imaging devices.

FIG. 1D illustrates two different types of hand-held imaging devices.

FIG. 2A illustrates optical focus and optical blurring.

FIG. 2B illustrates optical focus and optical blurring.

FIG. 2C illustrates optical focus and optical blurring.

FIG. 2D illustrates optical focus and optical blurring.

FIG. 3 illustrates focused and blurred text.

FIG. 4 illustrates a typical digitally encoded image.

FIG. 5 illustrates one version of the RGB color model.

FIG. 6 shows a different color model, referred to as the “hue-saturation-lightness” (“HSL”) color model.

FIG. 7 illustrates a difference between a focused image of a text character and an unfocused image of a text character.

FIG. 8 illustrates a discrete computation of an intensity gradient.

FIG. 9 illustrates a gradient computed for a point on a continuous surface.

FIG. 10 illustrates a number of intensity-gradient examples.

FIG. 11 illustrates the use of a three-pixel-spanning kernel that is convolved with a grayscale digital image to generate a contour image, or differential image, in which the pixel values represent the magnitudes of directional vectors representing the magnitude of the intensity gradient in a particular direction.

FIG. 12 illustrates computation of four different contour images from an example grayscale digital image.

FIG. 13 shows the result of computing contour images from the grayscale image discussed above with reference to FIG. 12.

FIG. 14 illustrates partitioning of a digital image into non-overlapping blocks.

FIG. 15 is the first in a series of control-flow diagrams that illustrate one implementation of a method that evaluates the suitability of a text-containing digital image for application of optical-character-recognition processing and other types of image processing.

FIG. 16 illustrates a histogram-based method for determining a contrast value for a particular block.

FIG. 17 illustrates intensity-value-based thresholding used to produce a binary image from a grayscale image.

FIG. 18 illustrates one approach to edge-pixel detection.

FIG. 19 provides a second control-flow diagram in the series of control-flow diagrams that illustrate one implementation of the currently disclosed preliminary-sharpness-analysis method.

FIG. 20 illustrates selection of candidate blocks from a source image and binary source image for subsequent sharpness analysis.

FIG. 21 illustrates determining of the number of sharp pixels, num_sharp, and the number of edge pixels, num_edge, in a block of the source image and derived images.

FIG. 22 provides control-flow diagrams that complete the description and illustration of a first implementation of the preliminary-sharpness-analysis method disclosed in the current document.

FIG. 23 provides control-flow diagrams that complete the description and illustration of a first implementation of the preliminary-sharpness-analysis method disclosed in the current document.

FIG. 24 provides control-flow diagrams that complete the description and illustration of a first implementation of the preliminary-sharpness-analysis method disclosed in the current document.

FIG. 25 illustrates a second implementation of the preliminary-sharpness-analysis method disclosed in the current document.

FIG. 26 illustrates a second implementation of the preliminary-sharpness-analysis method disclosed in the current document.

FIG. 27 illustrates a second implementation of the preliminary-sharpness-analysis method disclosed in the current document.

FIG. 28 illustrates a second implementation of the preliminary-sharpness-analysis method disclosed in the current document.

FIG. 29 illustrates a second implementation of the preliminary-sharpness-analysis method disclosed in the current document.

FIG. 30 illustrates a second implementation of the preliminary-sharpness-analysis method disclosed in the current document.

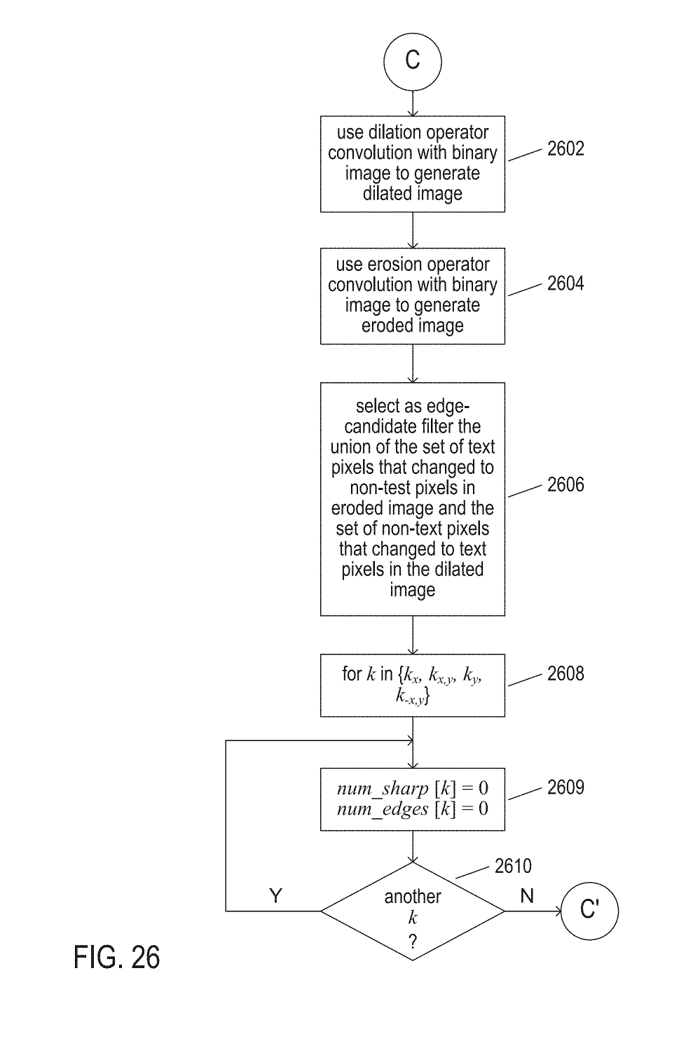

FIG. 26 provides control-flow diagrams that illustrate the alternative implementation of the preliminary-sharpness-analysis method disclosed in the current application.

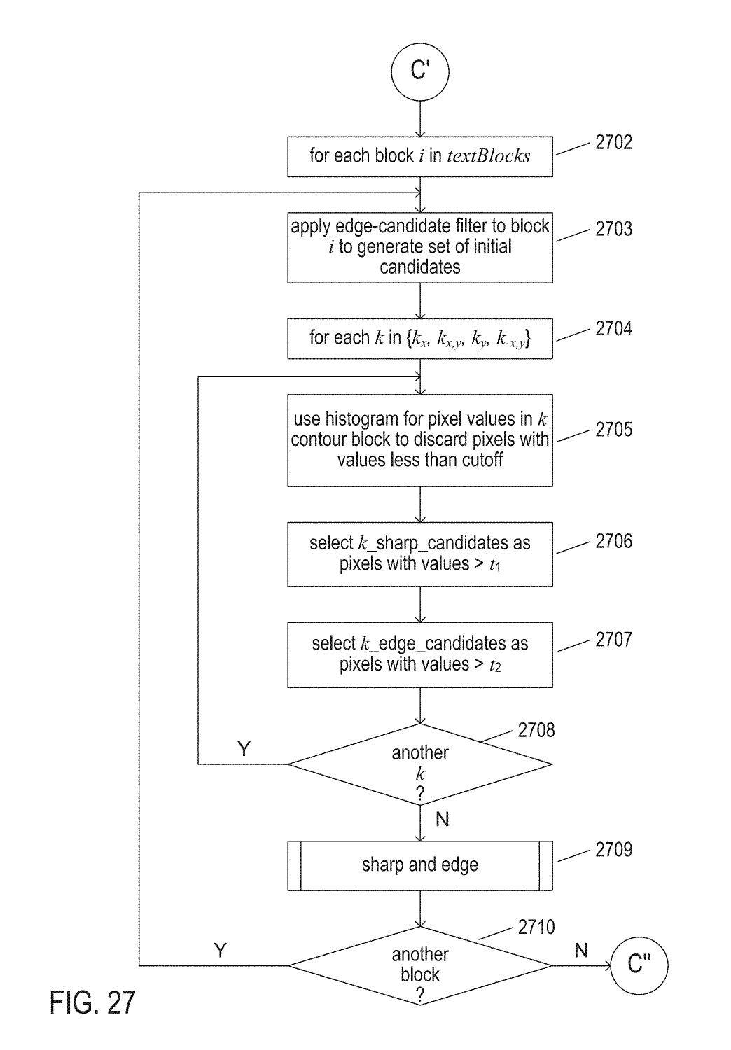

FIG. 27 provides control-flow diagrams that illustrate the alternative implementation of the preliminary-sharpness-analysis method disclosed in the current application.

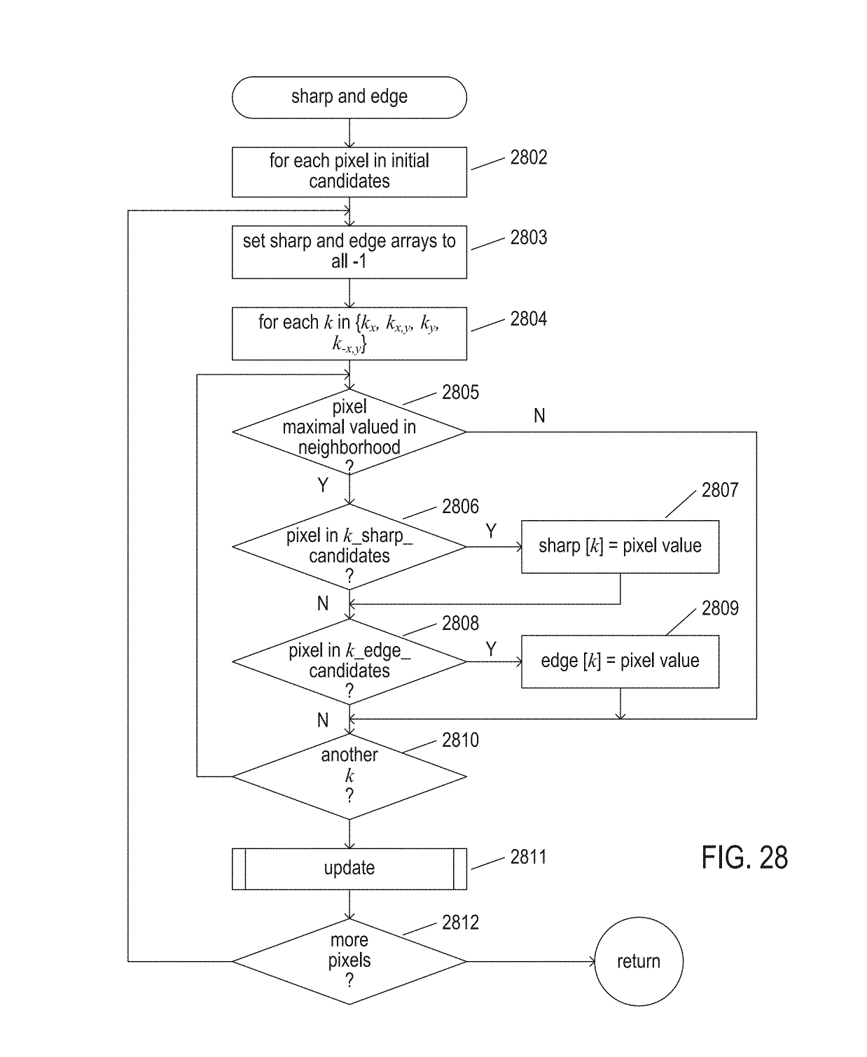

FIG. 28 provides control-flow diagrams that illustrate the alternative implementation of the preliminary-sharpness-analysis method disclosed in the current application.

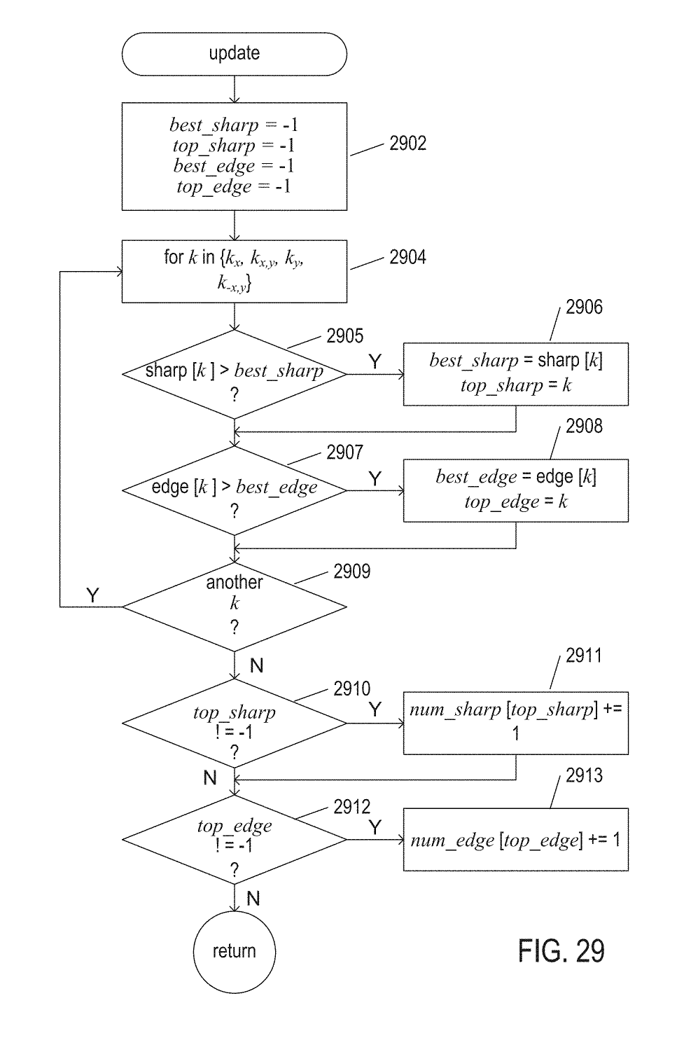

FIG. 29 provides control-flow diagrams that illustrate the alternative implementation of the preliminary-sharpness-analysis method disclosed in the current application.

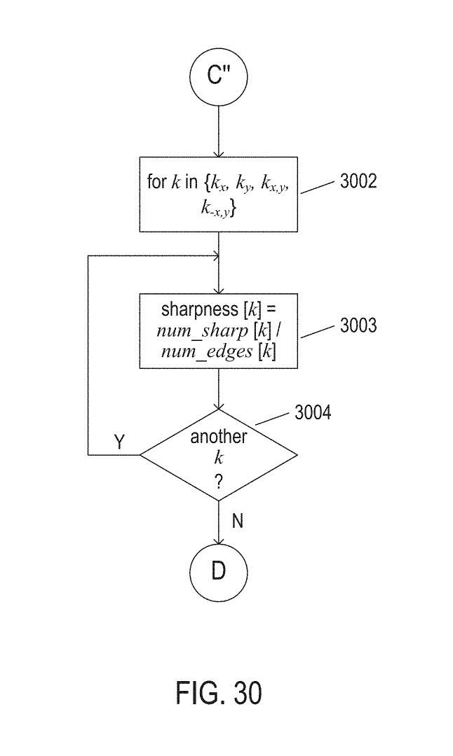

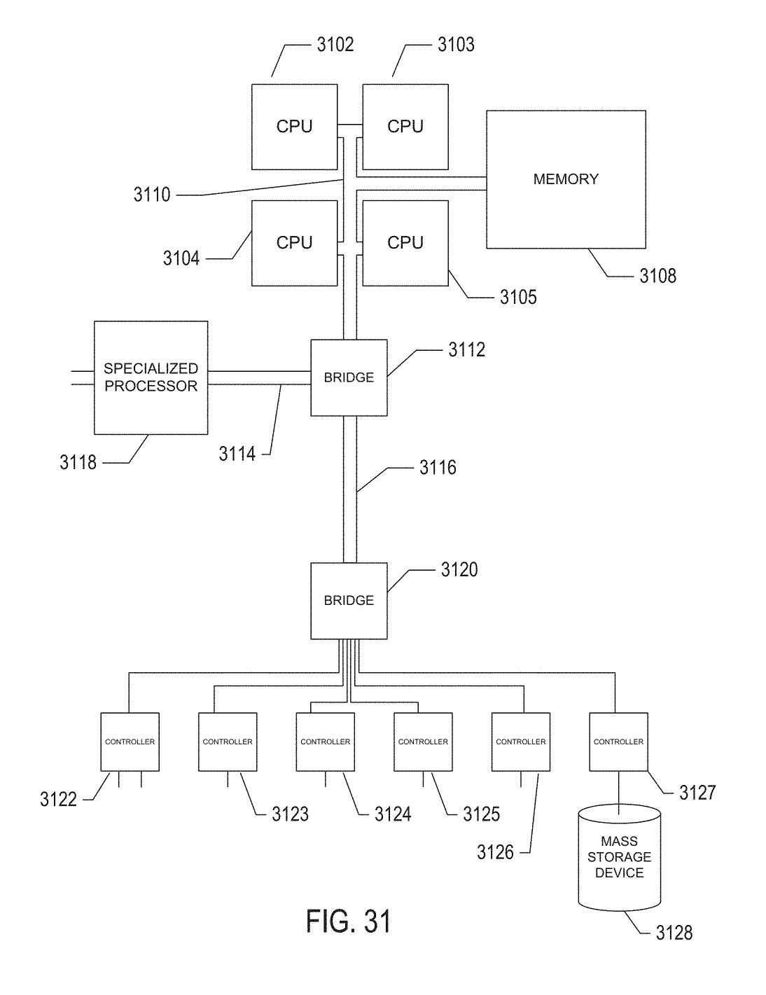

FIG. 30 provides control-flow diagrams that illustrate the alternative implementation of the preliminary-sharpness-analysis method disclosed in the current application.

FIG. 31 provides a high-level architectural diagram of a computer system, such as a computer system in which the currently disclosed preliminary-sharpness-analysis method is employed to obtain a suitability metric for subsequent image processing.

### DETAILED DESCRIPTION

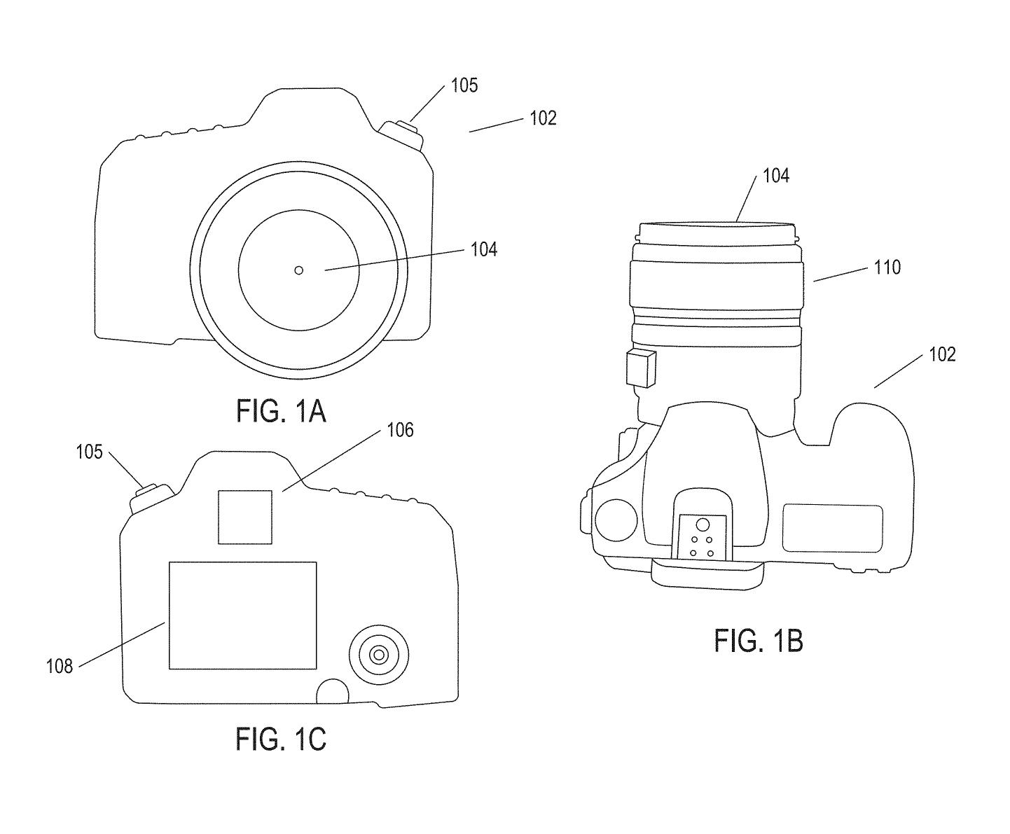

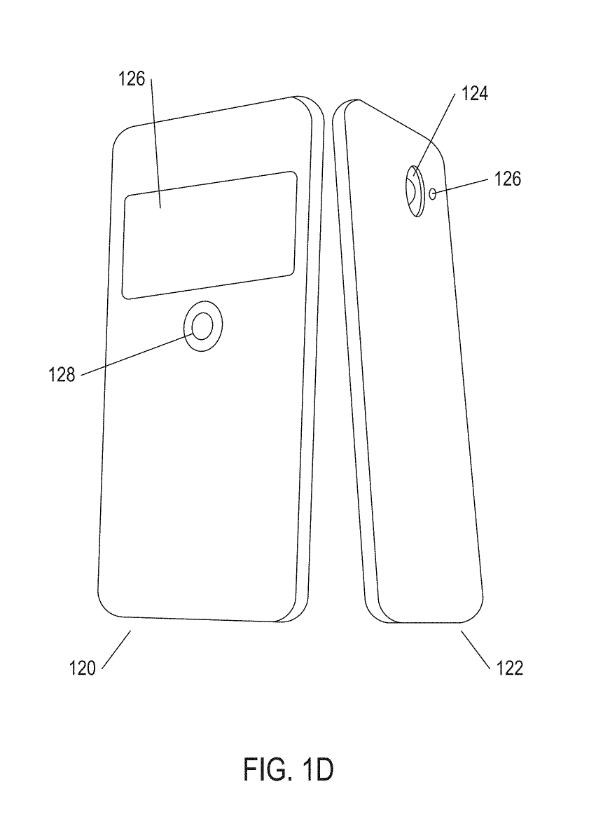

FIGS. 1A-D illustrate two different types of hand-held imaging devices. FIGS. 1A-C illustrate a digital camera 102. The digital camera includes an objective lens 104 and a shutter button 105 that, when depressed by a user, results in capture of a digital image corresponding to reflected light entering the lens 104 of the digital camera. On the back side of the digital camera, viewed by a user when the user is holding a camera to capture digital images, the digital camera includes a viewfinder 106 and an LCD viewfinder screen 108. The viewfinder 106 allows a user to directly view the image currently generated by the camera lens 104, while the LCD viewfinder screen 108 provides an electronic display of the image currently produced by the camera lens. Generally, the camera user adjusts the camera focus, using annular focus-adjusting features 110 while looking through the viewfinder 106 or observing the LCD viewfinder screen 108 in order to select a desired image prior to depressing the shutter button 105 to digitally capture the image and store the image in electronic memory within the digital camera.

FIG. 1D shows a typical smart phone from the front side 120 and from the back side 122. The back side 122 includes a digital-camera lens 124 and digital light meter and/or proximity sensor 126. The front side of the smart phone 120 may, under application control, display the currently received image 126, similar to the LCD viewfinder display 108 of the digital camera, as well as a touch-sensitive shutter-button 128, input of a touch to which captures a digital image within the smart-phone memory.

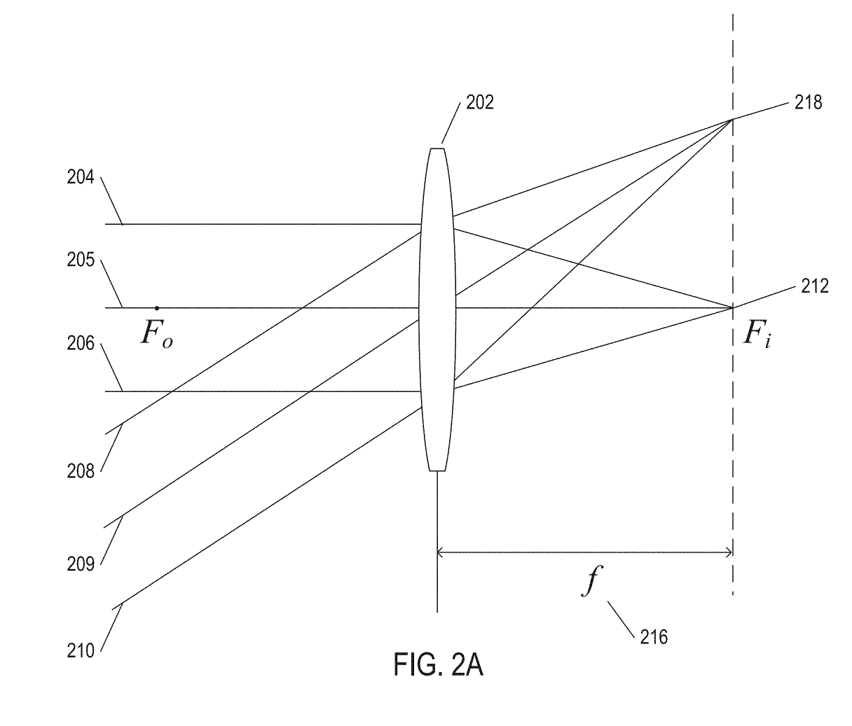

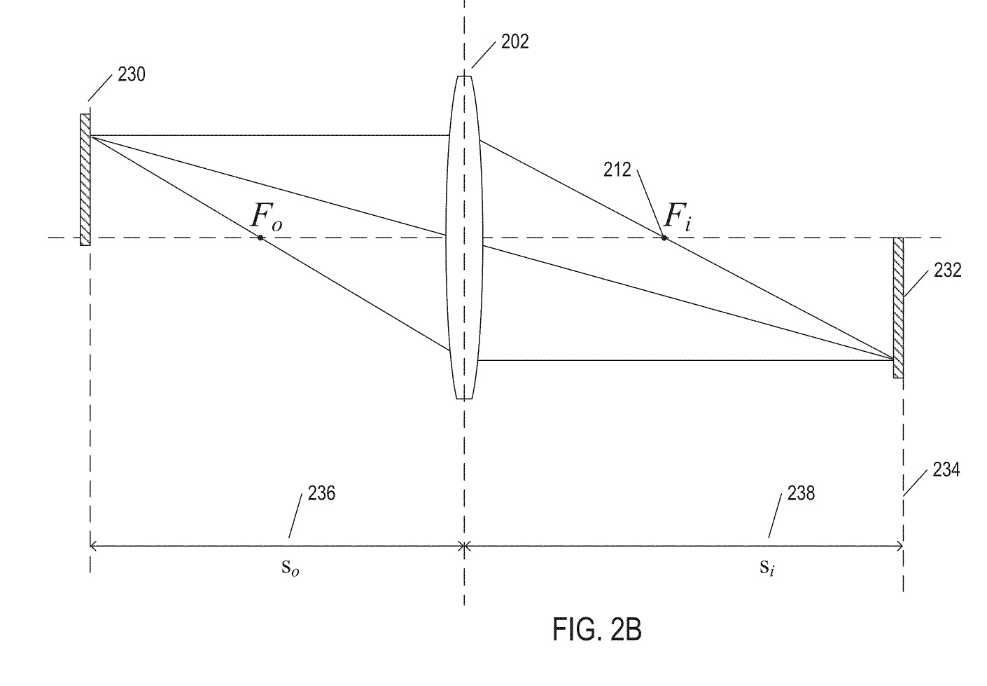

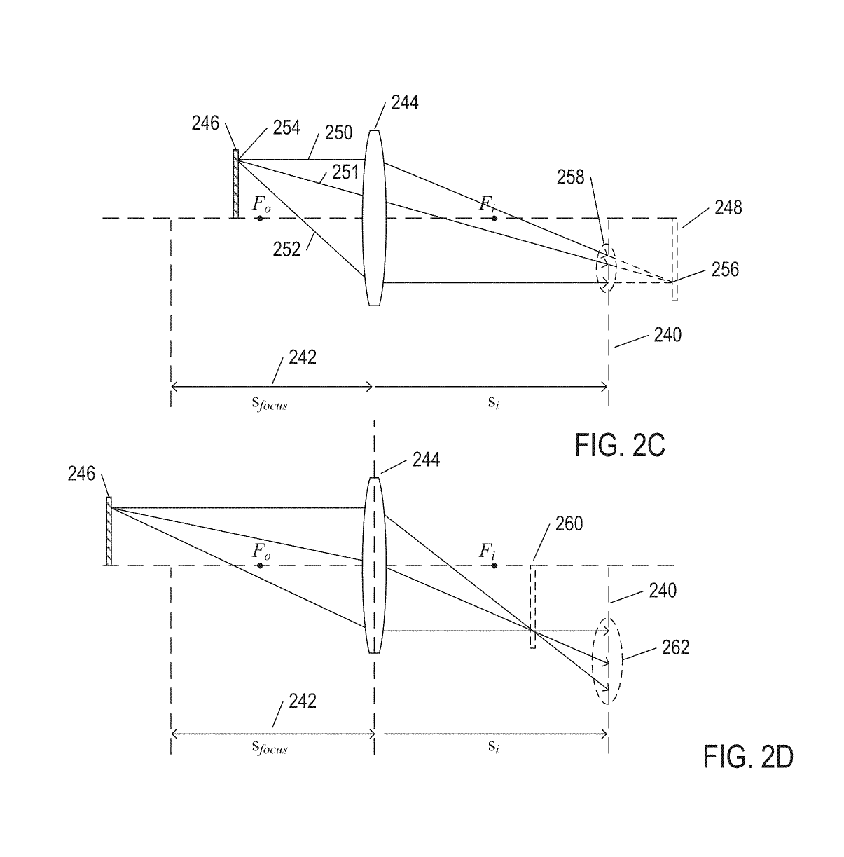

FIGS. 2A-D illustrate optical focus and optical blurring. FIG. 2A shows a side view of an optical lens 202 onto which parallel light rays from distant objects impinge. A first set of parallel light rays 204-206 arrive from a distant object lying close to the horizon or, in other words, from a direction of 180° with respect to the lens, and a second parallel set of light rays 208-210 arrive from a distant object at about 215° with respect to the lens. The first set of light rays converges at a point 212, lying on a focal plane 214 at a distance from the lens equal to the focal length f 216. The second set of parallel rays 208-210 converge at a second point 218 on the focal plane, above point 212. Thus, distant objects that produce essentially parallel light rays produce an inverted image on the focal plane 214 on the opposite side of the lens 202.

As shown in FIG. 2B, an object 230 closer to the lens 202 than the distant objects discussed with reference to FIG. 2A produces an inverted image 232 on a plane 234 further from the lens 202 than the focal point 212 for distant objects. Thus, for an object at a distance sₒ from the lens 236, there is a corresponding focal plane 234 at a distance sᵢ 238. In a camera, the distance from the imaging plane 234 and the lens is adjusted, by the focusing mechanism, to mechanically focus the image of an object. The nearer the object, the longer the distance between the lens and the imaging plane. Objects closer to the lens than a distance equal to the focal length cannot be imaged. Instead, after passing through the lens, rays generated from a point on such an object end up in non-converging paths on the opposite side of the lens.

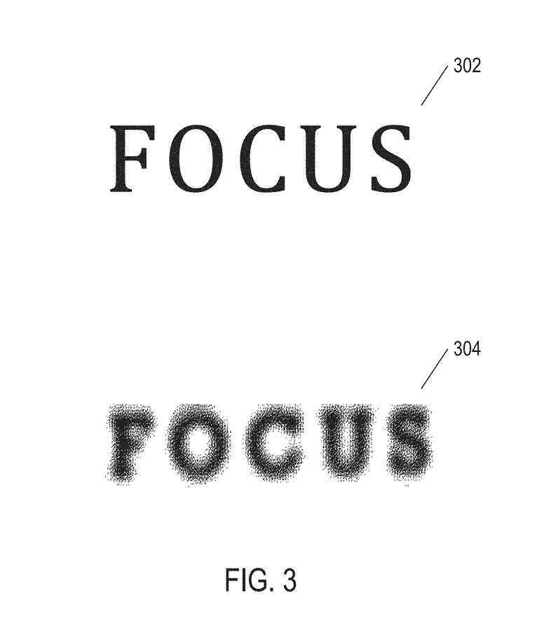

FIGS. 2C-D show image blurring. In both FIGS. 2C and 2D, the imaging plane 240 of a camera is positioned to image an object at a distance of s_{focus} 242 from the lens 244. When an object in the field of view is closer to the lens than s_{focus} 246, as shown in FIG. 2C, then a focused image 248 would occur behind the imaging plane 240. As a result, light rays 250-252 emanating from a particular point 254 on the surface of the object would converge at corresponding point 256 on the focused image 248, but failed to converge on the imaging plane 240. Instead, the rays fall over a disk-like area 258 on the imaging plane. Similarly, as shown in FIG. 2D, when the object 246 is at a distance from the lens greater than s_{focus}, the object would be imaged 260 in front of the imaging plane 240. Again, rather than converging to a point on the imaging plane, the optical rays are spread out over a disk-like region 262 on the imaging plane. Both in the case shown in FIG. 2C and in the case shown in FIG. 2D, the failure of rays emanating from a particular point on the object being imaged to converge on a corresponding point on the imaging plane, but instead falling within a disk-like region, results in optical blurring. FIG. 3 illustrates focused and blurred text. As shown in FIG. 3, the word “focus” appears sharply defined 302, when focused by a camera on the imaging plane, but appears diffuse 304. without distinct edges, when imaged by an unfocused camera in which the focused inverted image generated by the lens falls in front of, or behind, the imaging plane, as in FIGS. 2C-D.

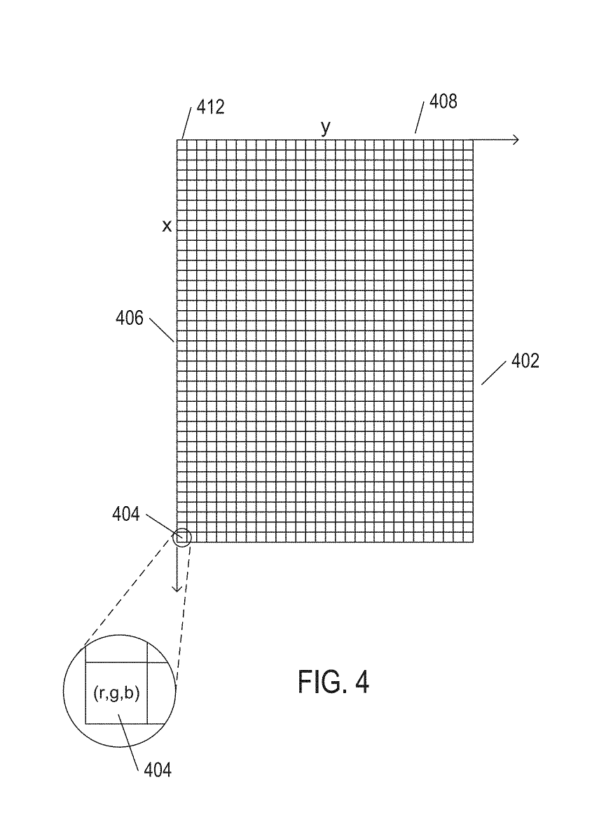

FIG. 4 illustrates a typical digitally encoded image. The encoded image comprises a two dimensional array of pixels 402. In FIG. 4, each small square, such as square 404, is a pixel, generally defined as the smallest-granularity portion of an image that is numerically specified in the digital encoding. Each pixel is a location, generally represented as a pair of numeric values corresponding to orthogonal x and y axes 406 and 408, respectively. Thus, for example, pixel 404 has x, y coordinates (39,0), while pixel 412 has coordinates (0,0). In the digital encoding, the pixel is represented by numeric values that specify how the region of the image corresponding to the pixel is to be rendered upon printing, display on a computer screen, or other display. Commonly, for black-and-white images, a single numeric value range of 0-255 is used to represent each pixel, with the numeric value corresponding to the grayscale level at which the pixel is to be rendered. In a common convention, the value “0” represents black and the value “255” represents white. For color images, any of a variety of different color-specifying sets of numeric values may be employed. In one common color model, as shown in FIG. 4, each pixel is associated with three values, or coordinates (r,g,b), which specify the red, green, and blue intensity components of the color to be displayed in the region corresponding to the pixel.

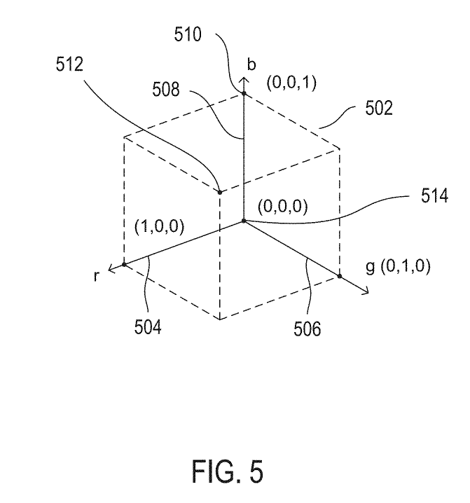

FIG. 5 illustrates one version of the RGB color model. The entire spectrum of colors is represented, as discussed above with reference to FIG. 4, by a three-primary-color coordinate (r,g,b). The color model can be considered to correspond to points within a unit cube 502 within a three-dimensional color space defined by three orthogonal axes: (1) r 504; (2) g 506; and (3) b 508. Thus, the individual color coordinates range from 0 to 1 along each of the three color axes. The pure blue color, for example, of greatest possible intensity corresponds to the point 510 on the b axis with coordinates (0,0,1). The color white corresponds to the point 512, with coordinates (1,1,1,) and the color black corresponds to the point 514, the origin of the coordinate system, with coordinates (0,0,0).

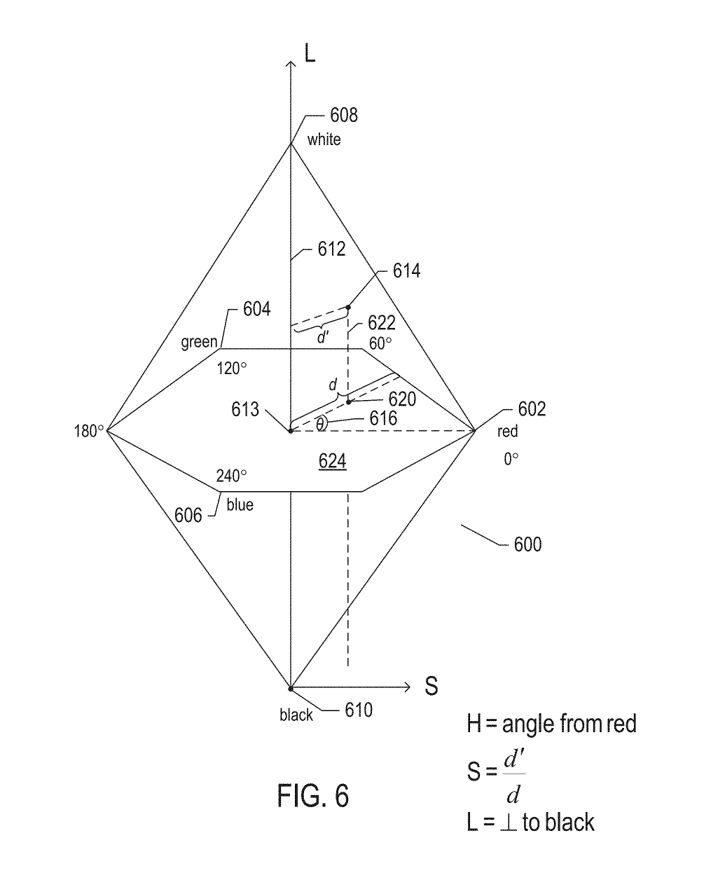

FIG. 6 shows a different color model, referred to as the “hue-saturation-lightness” (“HSL”) color model. In this color model, colors are contained within a three-dimensional bi-pyramidal prism 600 with a hexagonal cross section. Hue (h) is related to the dominant wavelength of a light radiation perceived by an observer. The value of the hue varies from 0° to 360° beginning with red 602 at 0°, passing through green 604 at 120°, blue 606 at 240°, and ending with red 602 at 660°. Saturation (s), which ranges from 0 to 1, is inversely related to the amount of white and black mixed with a particular wavelength, or hue. For example, the pure red color 602 is fully saturated, with saturation s=1.0, while the color pink has a saturation value less than 1.0 but greater than 0.0, white 608 is fully unsaturated, with s=0.0, and black 610 is also fully unsaturated, with s=0.0. Fully saturated colors fall on the perimeter of the middle hexagon that includes points 602, 604, and 606. A gray scale extends from black 610 to white 608 along the central vertical axis 612, representing fully unsaturated colors with no hue but different proportional combinations of black and white. For example, black 610 contains 100% of black and no white, white 608 contains 100% of white and no black and the origin 613 contains 50% of black and 50% of white. Lightness (l), or luma, represented by the central vertical axis 612, indicates the illumination level, ranging from 0 at black 610, with l=0.0, to 1 at white 608, with l=1.0. For an arbitrary color, represented in FIG. 6 by point 614, the hue is defined as angle θ 616, between a first vector from the origin 613 to point 602 and a second vector from the origin 613 to point 620 where a vertical line 622 that passes through point 614 intersects the plane 624 that includes the origin 613 and points 602, 604, and 606. The saturation is represented by the ratio of the distance of representative point 614 from the vertical axis 612, d′, divided by the length of a horizontal line passing through point 620 from the origin 613 to the surface of the bi-pyramidal prism 600, d. The lightness is the vertical distance from representative point 614 to the vertical level of the point representing black 610. The coordinates for a particular color in the HSL color model, (h,s,l), can be obtained from the coordinates of the color in the RGB color model, (r,g,b), as follows:

$$l = \frac{( {C}_{max} - {C}_{min} )}{2} , \\ h = \{ \begin{matrix}60 ° \times ( \frac{g - b}{Δ} mod 6 ) , when {C}_{max} = r \\ 60 ° \times ( \frac{b - r}{Δ} + 2 ) , when {C}_{max} = g \\ 60 ° \times ( \frac{r - g}{Δ} + 4 ) , when {C}_{max} = b \end{matrix} \} , and$$

$$s = \{ \begin{matrix}0 , Δ = 0 \\ \frac{Δ}{1 - \vert 2 l - 1 \vert} , otherwise\end{matrix} \} ,$$

where r, g, and b values are intensities of red, green, and blue primaries normalized to the range [0, 1]; Cₘₐₓ is a normalized intensity value equal to the maximum of r, g, and b; Cₘᵢₙ is a normalized intensity value equal to the minimum of r, g, and b; and Δ is defined as Cₘₐₓ—Cₘᵢₙ.

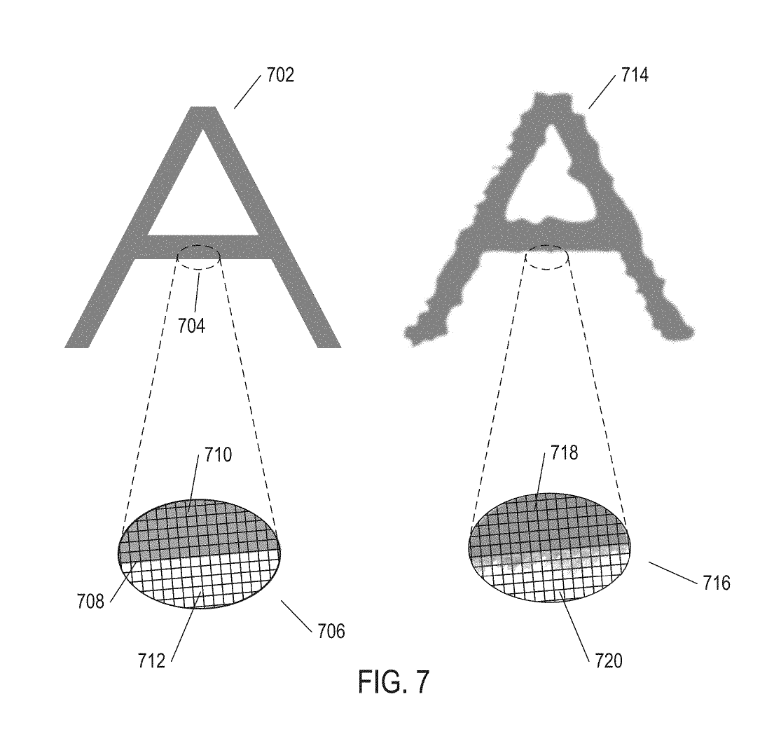

FIG. 7 illustrates a difference between a focused image of a text character and an unfocused image of a text character. A focused image of a text character 702 has sharp edges, or intensity edges, between the dark-colored symbol regions and light-colored background. A small portion 704 of the focused character is magnified, in insert 706, to show the pixels within the region. For a focused character, there is a sharp line or boundary 708 between the dark-colored pixels 710 and light-colored pixels 712. By contrast, in an unfocused image of the character 714, the edges are not distinct, and, as shown in inset 716, there is no sharp boundary between the dark-colored pixels 718 and light-colored background pixels 720.

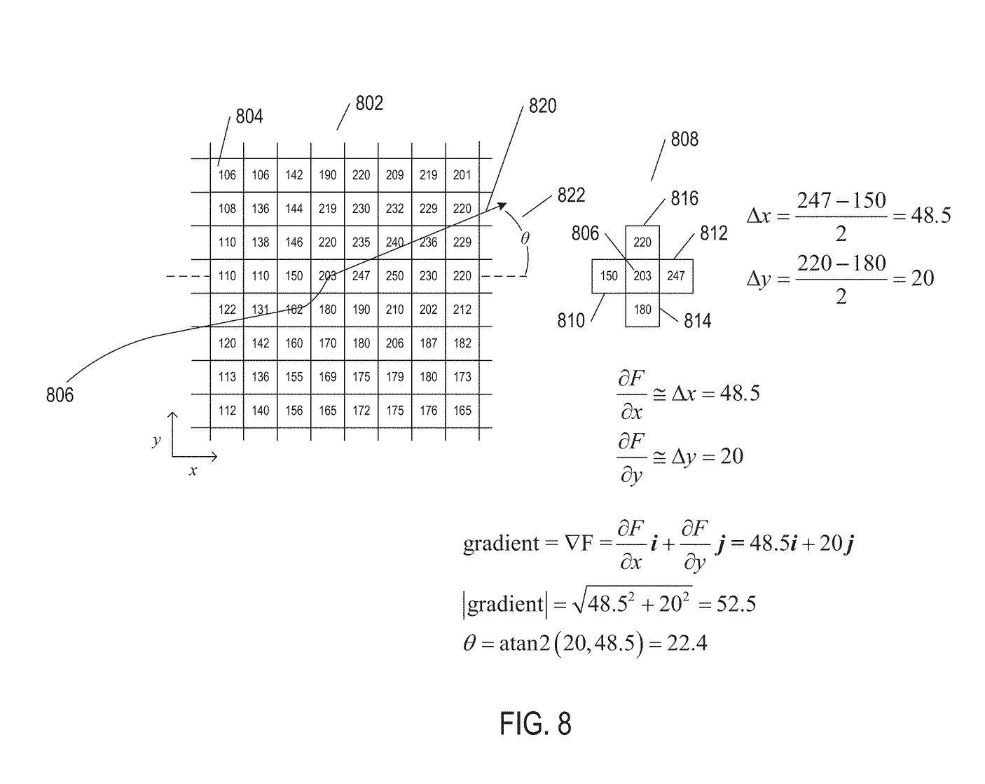

One way of computationally detecting edges in an image, such as the edge 708 shown in inset 706 of FIG. 7, is by estimating the intensity gradient vector for each pixel, assuming that the image is a function z=F(x,y) where (x,y) are the coordinates of pixels and z is the intensity value. Because images are discrete functions, rather than continuous functions, the continuous partial-differential expressions for computing the gradient do not apply. However, a digital image can be assumed to be a grid-like sampling of an underlying continuous intensity function, and the gradient corresponding to the sample points estimated by discrete operations. FIG. 8 illustrates a discrete computation of an intensity gradient. In FIG. 8, a small square portion 802 of a digital image is shown. Each cell, such as cell 804, represents a pixel and the numeric value within the cell, such as the value “106” in cell 804, represents a grayscale intensity. Consider pixel 806 with the intensity value “203.” This pixel, and four contiguous neighbors, are shown in the cross-like diagram 808 to the right of the portion 802 of the digital image. Considering the left 810 and right 812 neighbor pixels, the change in intensity value in the x direction, Δx, can be discretely computed as:

$$Δ x = \frac{247 - 150}{2} = 48.5 .$$

Considering the lower 814 and upper 816 pixel neighbors, the change in intensity in the vertical direction, Δy, can be computed as:

$$Δ y = \frac{220 - 180}{2} = 20.$$

The computed Δx is an estimate of the partial differential of the continuous intensity function with respect to the x coordinate at the central pixel 806:

$$\frac{\partial F}{\partial x} ≅ Δ x = 48.5 .$$

The partial differential of the intensity function F with respect to the y coordinate at the central pixel 806 is estimated by Δy:

$$\frac{\partial F}{\partial y} ≅ Δ y = 20.$$

The intensity gradient at pixel 806 can then be estimated as:

$$gradient = ∇ F = \frac{\partial F}{\partial x} i + \frac{\partial F}{\partial y} j = 48.5 i + 20 j$$

where i and j are the unit vectors in the x and y directions. The magnitude of the gradient vector and the angle of the gradient vector are then computed as:

|gradient|=\sqrt{48.5²}+20²=52.5θ=atan2(20, 48.5)=22.

[symbol]

The direction of the intensity gradient vector 820 and the angle θ 822 are shown superimposed over the portion 802 of the digital image in FIG. 8. Note that the gradient vector points in the direction of steepest increase in intensity from pixel 806. The magnitude of the gradient vector indicates an expected increase in intensity per unit increment in the gradient direction. Of course, because the gradient is only estimated by discrete operations, in the computation illustrated in FIG. 8, both the direction and magnitude of the gradient are merely estimates.

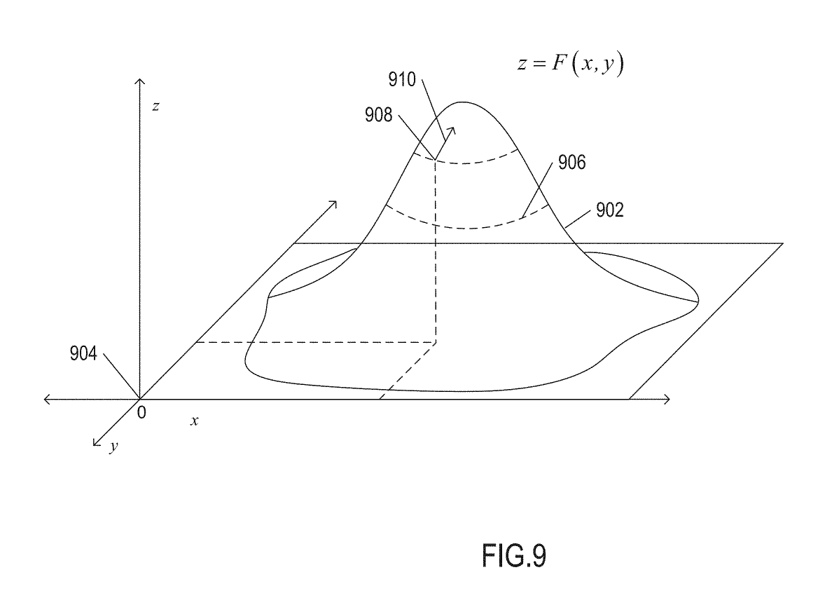

FIG. 9 illustrates a gradient computed for a point on a continuous surface. FIG. 9 illustrates a continuous surface z=F(x,y). The continuous surface 902 is plotted with respect to a three-dimensional Cartesian coordinate system 904, and has a hat-like shape. Contour lines, such as contour line 906, can be plotted on the surface to indicate a continuous set of points with a constant z value. At a particular point 908 on a contour plotted on the surface, the gradient vector 910 computed for the point is perpendicular to the contour line and points in the direction of the steepest increase along the surface from point 908.

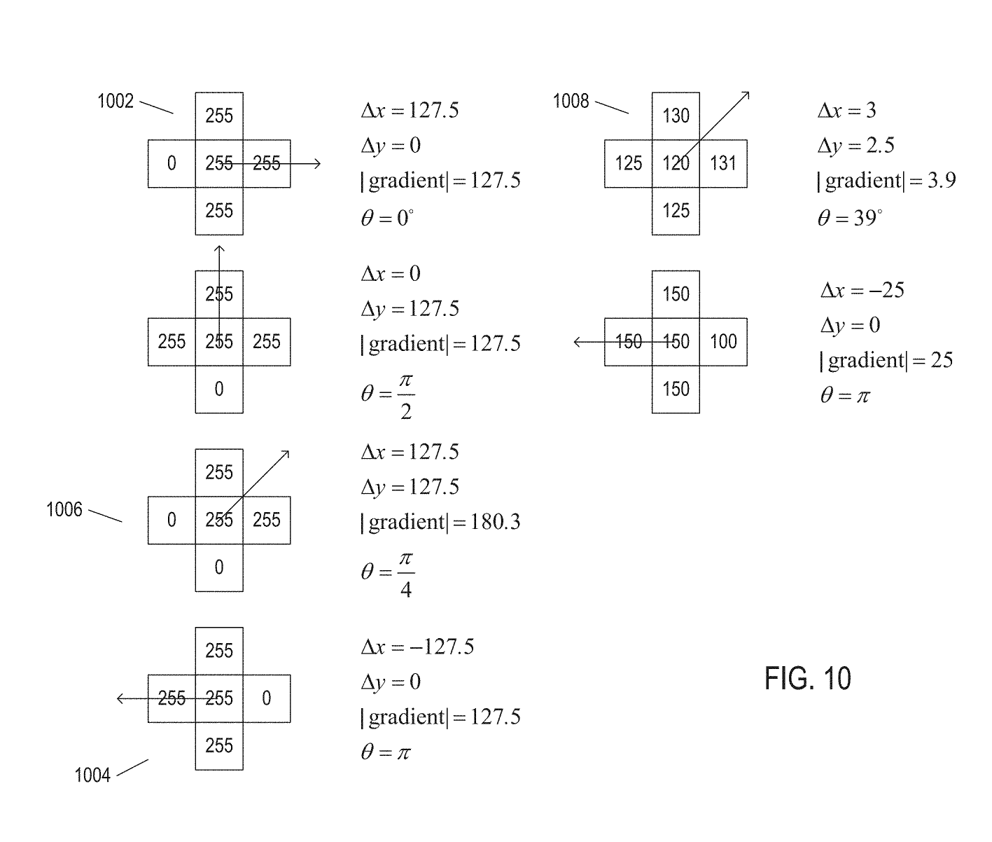

In general, an intensity gradient vector is oriented perpendicularly to an intensity edge, and the greater the magnitude of the gradient, the sharper the edge or the greatest difference in intensities of the pixels on either side of the edge. FIG. 10 illustrates a number of intensity-gradient examples. Each example, such as example 1002, includes a central pixel for which the gradient is computed and the four contiguous neighbors used to compute Δx and Δy. The sharpest intensity boundaries are shown in the first column 1004. In these cases, the magnitude of the gradient is at least 127.5 and, for the third case 1006, 180.3. A relatively small difference across an edge, shown in example 1008, produces a gradient with a magnitude of only 3.9. In all cases, the gradient vector is perpendicular to the apparent direction of the intensity edge through the central pixel.

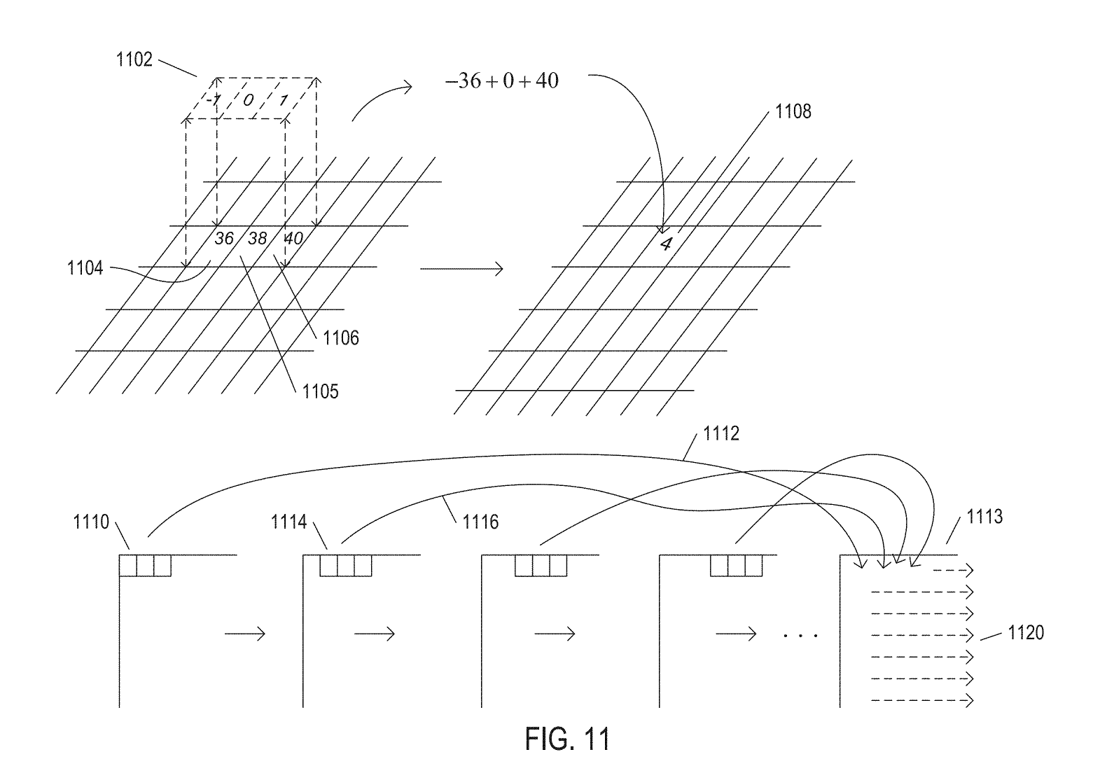

FIG. 11 illustrates the use of a three-pixel-spanning kernel that is convolved with a grayscale digital image to generate a contour image, or differential image, in which the pixel values represent the magnitudes of directional vectors representing the an intensity gradient component in a particular direction. The contour image computed in FIG. 11 is the contour image for the direction along the x axis, with the intensity values of pixels in the contour image representing the component of the gradient vector in the x direction, or

$$\frac{\partial F}{\partial x} .$$

In fact, the computed intensity values are related to the actual magnitudes of the gradient vector in the x direction by the multiplier 2. In order to facilitate computational efficiency, the difference between the left and right pixel values is not divided by 2. The three-pixel kernel 1102 is shown in dashed lines superimposed over three pixels 1104-1106 within a small portion of the digital image. Application of the kernel to these three pixels produces the value related to the magnitude of the gradient in the x direction, 4, which is entered as the value for the central pixel 1108 of the three pixels 1104-1106 in the original grayscale image. As shown in FIG. 11, the kernel 1102 is applied to the three pixels by multiplying each kernel value with the corresponding underlying pixel intensity. As shown in the lower portion of FIG. 11, the kernel is applied to each pixel, other than the left and right border pixels, of a digital image in an operation referred to as “convolution.” Application of the kernel to each pixel involves centering of the kernel over the pixel, as kernel 1102 is centered over pixel 1105 in the top left-hand side of FIG. 11, and then computing the value related to the magnitude of the gradient in the x direction. Initially, the kernel is positioned in order to compute a value for the second left-most top pixel 1110. This value is then placed into the contour image, as represented by curved arrow 1112. Then, the kernel is slid to the right by one pixel 1114 and a next contour-image pixel value is computed and placed, as indicated by curved arrow 1116, into the contour image 1113. This process continues, as indicated by dashed arrows 1120 in FIG. 11, in raster-scan-like fashion in order to compute contour-image pixel values for all but the left-side border and right-side border pixels of the original grayscale image. In certain cases, a modified kernel may be used to compute estimated values for the border pixels, with the modified kernel having only two rather than three values.

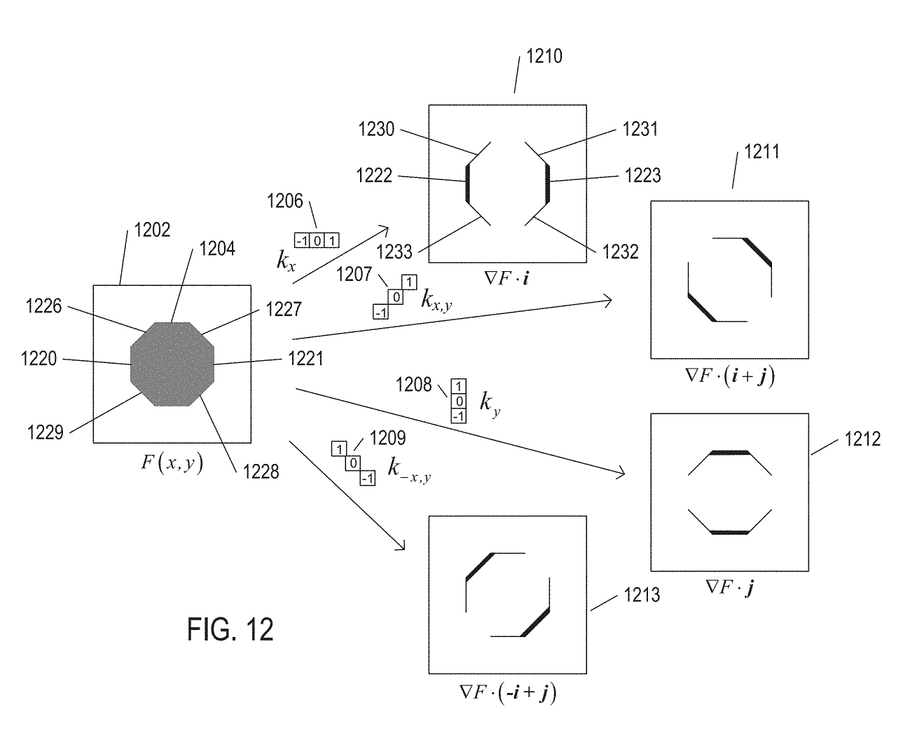

FIG. 12 illustrates computation of four different contour images from an example grayscale digital image. The example grayscale digital image 1202 has a light background with a dark, octagon-shaped central feature 1204. Four different kernels 1206-1209 are convolved separately with the grayscale image 1202 to produce four different contour images 1210-1213. Consider the kernel kₓ 1206. This is the kernel discussed above with reference to FIG. 11. It computes the magnitude of the gradient in the x direction. Therefore, any edges in the grayscale digital image perpendicular to the x direction will have large computed values in the contour image. These include the left edge 1220 and the right edge 1221 of the octagon 1204. In the resulting contour image 1210, l these two edges 1222 and 1223 have large values. They are shown as dark lines, but because, in grayscale convention, large values tend towards white while low values tend towards black, the contour images 1210-1213 in FIG. 12 are color-convention inverted, to clearly show, using dark lines, the high-intensity pixels in the contour images. Were actual color-true representations shown, the contour images would be mostly black with white edge features. The diagonal edges of the octagon 1226-1229 are neither perpendicular nor parallel to the x direction. Therefore, the x-direction component of the direction perpendicular to these diagonal edges has a significant, but smaller magnitude than the x-direction component of the gradient vector for the vertical edges 1220 and 1221. Thus, the diagonal edges in the contour image 1230-1233 are visible in the contour image, but have less intensity than the two vertical edges 1222 and 1223. A similar analysis for the three additional kernels 1207-1209 explains the differently oriented pairs of features in each of the corresponding contour images 1211-1213. Note that the naming convention for the kernels uses subscripts to indicate the directions for which the kernels compute gradient magnitudes. For example, kernel 1207 is referred to as “k_{x,y}” because the kernel computes the magnitude of the gradient vector component in the direction i+j.

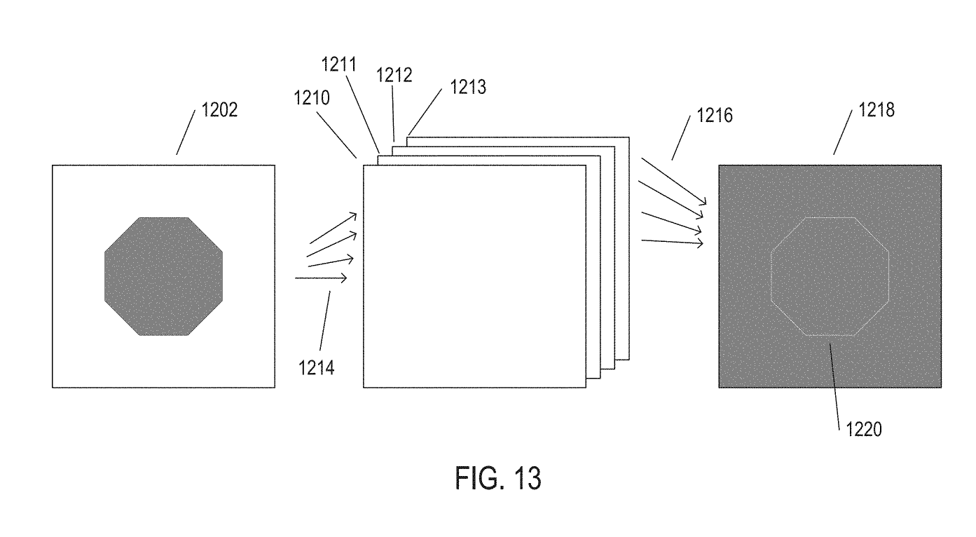

FIG. 13 shows the result of computing contour images from the grayscale image discussed above with reference to FIG. 12. The original grayscale image 1202 is convolved with the four different kernels 1206-1209 to produce the four contour images 1210-1213, the four convolutions represented in FIG. 13 by the four arrows 1214. As represented by a second set of arrows 1216, the four contour images can be added together, with the contour-image pixel values for a particular pixel at a particular coordinate in all four contour images added together to produce a resulting summed pixel value which is then divided by an appropriate constant value so that the largest pixel value in a combined contour image 1218 is less than or equal to 255. The combined contour image 1218 has a white-line representation of the edges of the octagon 1220 on an otherwise dark background. Thus, combination of the four contour images produce a final, composite contour image 1218 with intensity edges in the original grayscale image in bright or white color and non-edge pixels in the original grayscale image in dark colors. In other words, the discrete differential operators, or kernels, are convolved with a grayscale image in order to detect edges within the image.

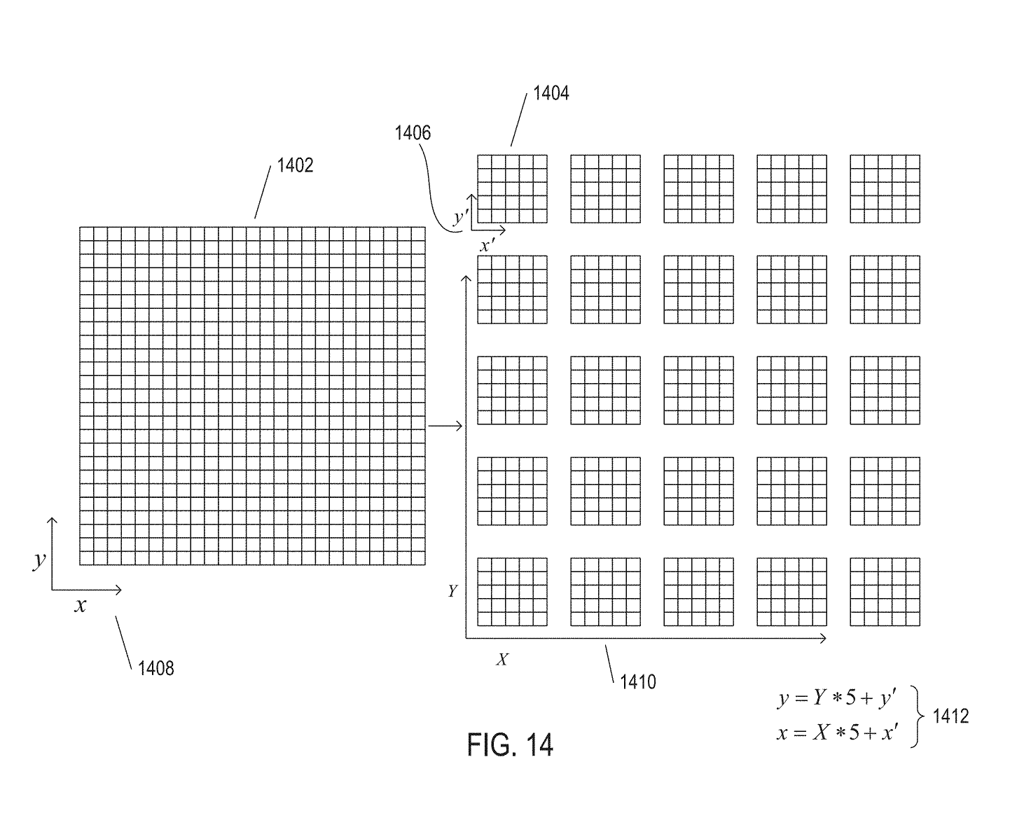

FIG. 14 illustrates partitioning of a digital image into non-overlapping blocks. In FIG. 14, a small digital image 1402 includes 625 pixels, 25 pixels on a side. This image can be partitioned into, as one example, 25 smaller 5×5 blocks, such as 5×5 block 1404. The individual blocks may be associated with individual-block coordinate system x′,y′ 1406. The original image may be associated with a two-dimensional x,y coordinate system 1408. The 25 smaller blocks may be associated with a two-dimensional x,y Cartesian coordinate system 1410, each point in which corresponds to a block, with each location associated with internal coordinates corresponding to a 5×5 block. Of course, partitioning of an image into smaller non-overlapping blocks, as shown in FIG. 14, does not necessarily involve copying values to different memory locations, but simply using a different indexing method to access pixel values in the image. For example, there is a linear transformation between the coordinates of a pixel in the original image (x,y) and the block coordinates of the block containing the pixel (X,Y) and the local position of the pixel within the block (x′,y′), shown by equations 1412 in FIG. 14. Thus, image partitioning may simply be a matter of employing different coordinate sets and linear transformations between them.

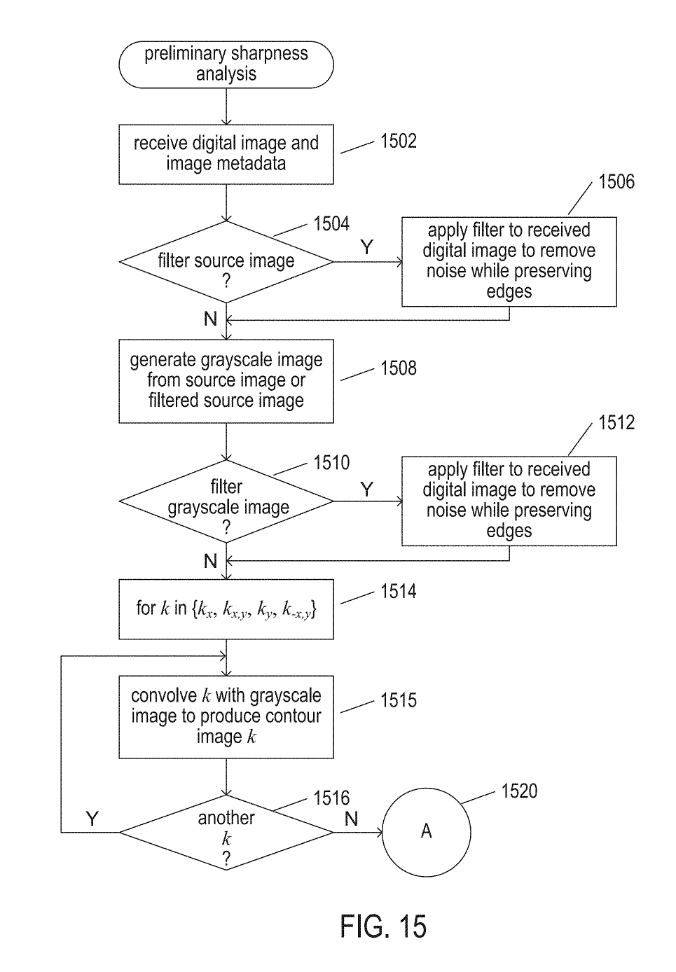

FIG. 15 is the first in a series of control-flow diagrams that illustrate one implementation of a method that evaluates the suitability of a text-containing digital image for application of optical-character-recognition processing and other types of image processing. This implementation is referred to as “preliminary sharpness analysis.” In a first step 1502, the disclosed preliminary-sharpness-analysis method receives a digital image and image metadata. The image metadata may be an image header that includes various parameters that characterize the image, including the color model used, the dimensions of the image, in pixels, the particular type of pixel encoding, and other such parameters. The received digital image may be, as one example, the image displayed in the LCD viewfinder screen of a camera or displayed by a smart-phone application to represent the current image being received through an optical device to allow a user of a camera or other imaging device to adjust the focus, position and orientation, aperture, and other parameters of the optical device in order to obtain a desired image and image quality prior to activating the imaging device to capture a desired image as a digital image and store the digital image in device memory. As another example, various types of computational systems may employ the preliminary-sharpness-analysis method to evaluate digital images received from a variety of different types of sources for image processing prior to conducting the image processing, in order to avoid the temporal and computational expenses associated with the application of image processing to blurred, noisy, or otherwise unsuitable digital images. When the preliminary-sharpness-analysis-method implementation is designed or controlled by input arguments or parameters values to initially filter the received source image, as determined in step 1504, then any of various different types of image filters are applied to the received source digital image to remove noise while preserving contrast and, in particular, preserving intensity edges, in step 1506. An example type of filter that may be applied is a bilateral filter that uses Gaussian-distribution-based weighting. A general expression for the bilateral filter is provided below:

$${I}^{filtered} ( x ) = \frac{1}{{W}_{p}} {\sum }_{{x}_{i} ∈ Ω} I ( {x}_{i} ) {f}_{r} ( \vert \vert I ( {x}_{i} ) - I ( x ) \vert \vert ) {g}_{s} ( \vert \vert {x}_{i} - x \vert \vert ) ,$$

where the normalization term

$${W}_{p} = {\sum }_{{x}_{i} ∈ Ω} {f}_{r} ( \vert \vert I ( {x}_{i} ) - I ( x ) \vert \vert ) {g}_{s} ( \vert \vert {x}_{i} - x \vert \vert )$$

ensures that the filter preserves image energy and where

I^{filtered} is the filtered image;

I is the original input image to be filtered;

x are the coordinates of the current pixel to be filtered;

Ω is the window centered in x;

f, is the range kernel for smoothing differences in intensities; and

gₛ is the spatial kernel for smoothing differences in coordinates.

Then, in step 1508, a grayscale image is generated from the source image, in the case that the source image is a colored image. Generation of a grayscale image from a colored image can be carried out by a variety of different methods, depending on the particular color scheme used for encoding the color image. In the case of an image encoded in the HSL color scheme, discussed above, the luma component of the three components that define the color and intensity of a pixel can be used as the grayscale intensity value associated with each pixel in a grayscale image. In the case that the source image was already a grayscale image or monotone image, step 1508 may involve only normalizing intensity values to the range (0,255), in cases where the intensity values are not encoded in eight bits. In the case that the implementation is designed, or controlled, by input arguments or parameter values, to apply a filter to the grayscale image, as determined in step 1510, then a noise-reducing but edge-preserving filter is applied to the grayscale image in step 1512. In many implementations, either the source image is filtered or the grayscale image is filtered. Other types of preliminary processing, including additional types of filters, may be applied in either or both steps 1506 and 1512.

In the for-loop of steps 1514-1516, the four different discrete-differentiation-operator kernels kₓ, kₓ, k_{x,y}, k_{y}, and k_{-x,y}, discussed above with reference to FIG. 12, are convolved with the grayscale image to produce corresponding contour images, as shown in FIG. 12. In FIG. 15, and in subsequent figures, the variable k is used to indicate one of the set of contour images and as an index into various array variables.

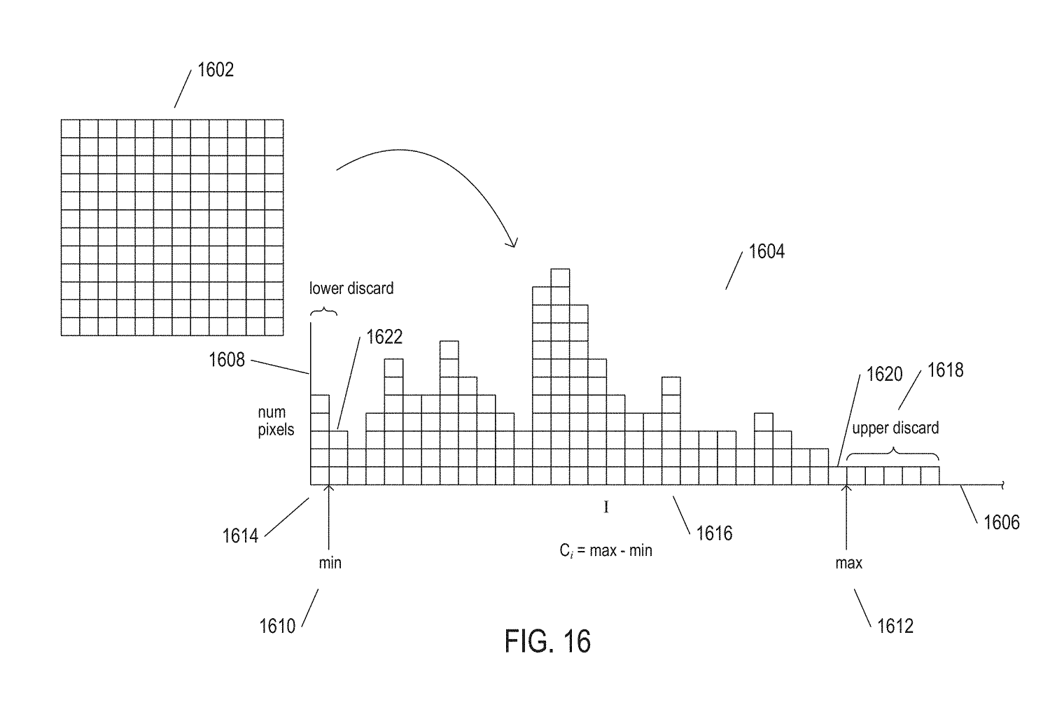

FIG. 16 illustrates a histogram-based method for determining a contrast value Cᵢ for a particular block i of a set of non-overlapping blocks into which a digital image is partitioned. In this method, the intensity values associated with pixels in the block 1602 are computationally sorted to produce a logical histogram 1604, in which the sorted intensity values are arranged in columns along a horizontal axis 1606. The height of a column represents the number of pixels with the particular intensity value, represented by a vertical axis 1608. In a next step, predetermined or computed minimum intensity and maximum intensity values 1610 and 1612 are applied to the histogram to partition the histogram into a lower discard region 1614, a central region 1616, and an upper discard region 1618. As one example, the minimum and maximum values 1610 and 1612 can be computed so that some specified percent of the pixels of the block 1602 lie in the lower discard partition and a specified percent of the pixels of the block lie in the upper-discard region 1618. The lower and upper discard partitions represent pixels with outlying values. In one implementation, 0.1 percent of the total number of pixels are desired to reside in both the lower-discard region 1614 and the upper-discard region 1618. In a final step, the contrast Cᵢ for block i 1602 is computed as the difference between the maximum intensity value 1620 and the minimum intensity value 1622 in the central portion or partition 1616 of the histogram. In other words, after exclusion of outlying intensity values, the contrast is computed as the difference between the maximum and minimum values within the block.

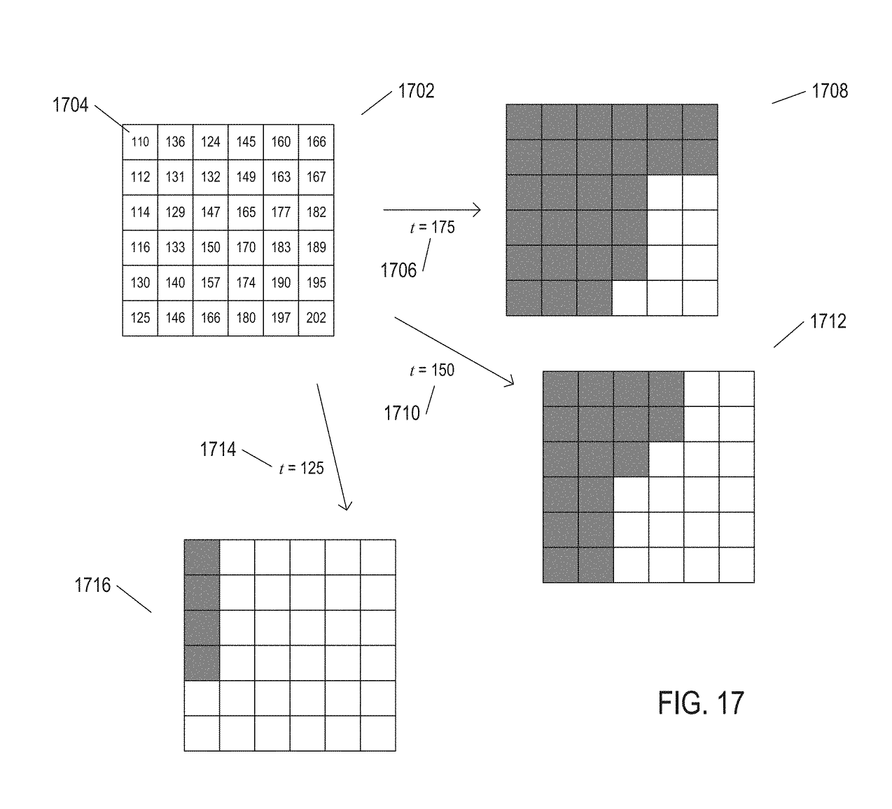

FIG. 17 illustrates intensity-value-based thresholding used to produce a binary image from a grayscale image. A binary image contains pixels each having one of two possible values, such as the values “0” and “255.” In other words, all of the pixels are either white or black. Alternatively, a binary image can be more economically represented by single-bit pixel values that include the values “0” and “1.” In FIG. 17, a block from a grayscale image 1702 is shown with numeric grayscale values associated with the pixels. For example, pixel 1704 is associated with grayscale value 110. This block can be alternatively transformed into a binary image using different threshold values. For example, when the threshold value is 175, pixels with values less than 175 are associated with the value “0”, in the corresponding binary image 1708, and pixels with the value 175 or greater are associated with the value “255” in the binary image, under one convention, or the value “1,” under another convention. In this case, because of the distribution of intensity values in the image block 1702, the majority of pixels in the corresponding binary-image block 1708 have the value 0, and are shown in FIG. 17 as darkly colored. When the threshold value is “150” (1710), the binary image 1712 produced by thresholding includes fewer darkly colored pixels and a greater number of white pixels. When the threshold is lowered to “125” (1714), only a few of the pixels in the binary image 1716 are darkly colored.

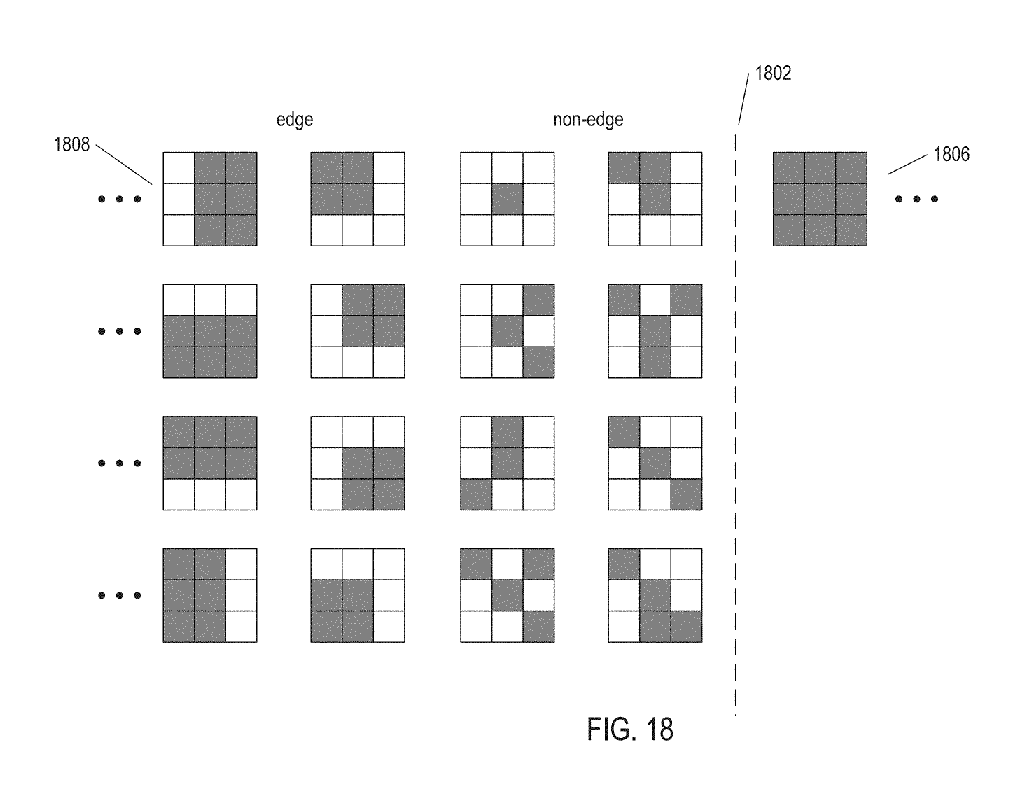

In one step of the preliminary sharpness analysis, the pixels in a binary image corresponding to the grayscale image produced from the source image are classified as being either edge pixels or non-edge pixels. There are numerous approaches to classification of pixels as being edge pixels and non-edge pixels. FIG. 18 illustrates one approach to edge-pixel detection. In this approach, a 3×3 kernel is centered over a pixel for which a determination is to be made. When the pattern of white and black pixels in the kernel correspond to the values of the pixel in question and to its neighboring pixels in a binary image, then the pixel is classified as being an edge pixel or a non-edge pixel according to whether the kernel has been predetermined to represent an edge kernel or a non-edge kernel. In FIG. 18, a number of edge kernels are shown to the left of a vertical dashed line 1802 and a number of non-edge kernels are shown to the right of the dashed line. When the central pixel is dark and all of the neighboring pixels are dark, as represented by kernel 1806, the central pixel is reasonably classified as a non-edge pixel. When the central pixel is dark and a vertical column of pixels adjacent to the central pixel are white, as represented by kernel 1808, the central pixel is reasonably classified as an edge pixel. In one implementation, a pixel is classified as an edge pixel when it is dark and at least one neighboring pixel is white. Thus, in FIG. 18, all of the kernels to the left of the vertical dashed line 1802 are edge kernels, in this implementation. However, in alternative implementations, the partitioning of possible 512 edge-detection kernels or patterns between edge kernels, to the left of the vertical dashed line 1802, and non-edge kernels, to the right of the vertical dashed line 1802, may differ. More efficient methods may employ a small number of logical statements to classify a pixel as being an edge pixel or a non-edge pixel depending on the binary values associated with its immediate neighbors, providing the same edge/non-edge classification as provided the edge-detection-kernel method.

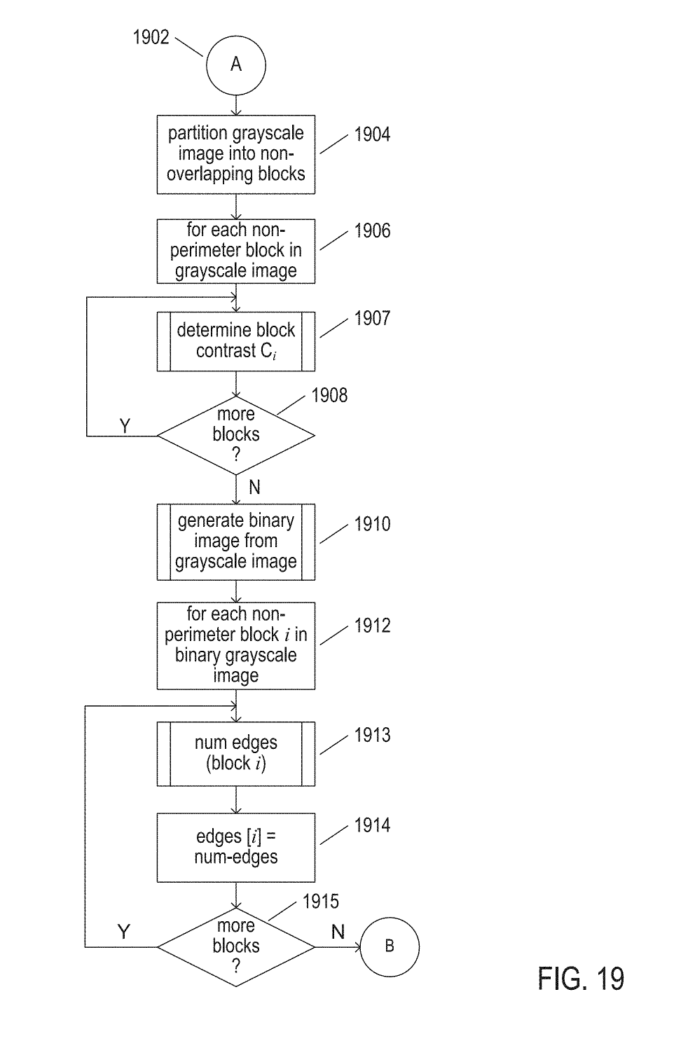

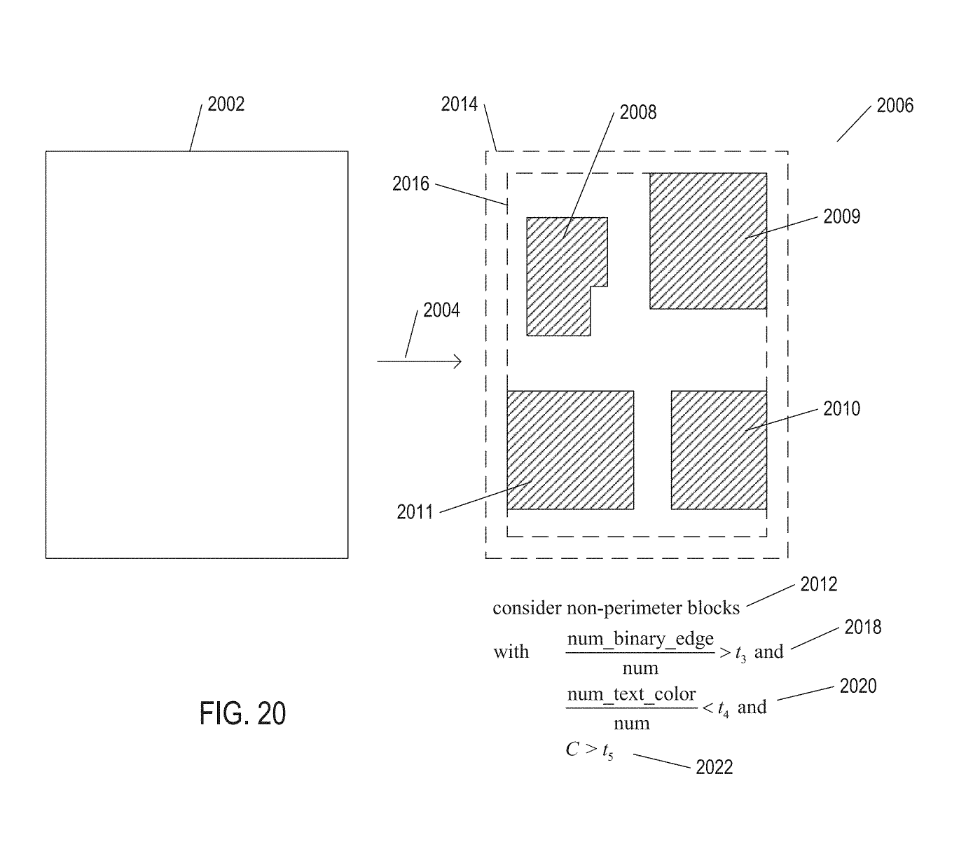

FIG. 19 provides a second control-flow diagram in the series of control-flow diagrams that illustrate one implementation of the currently disclosed preliminary-sharpness-analysis method. The circled symbol “A” 1902 indicates a continuation of the control flow from the corresponding circled symbol “A” 1520 in the control-flow diagram provided in FIG. 15. Similar illustration conventions are used to connect together subsequent control-flow diagrams. In step 1904, the grayscale image is partitioned into non-overlapping blocks. Partitioning of an image is discussed above with reference to FIG. 14. A variety of different types of partitioning may be employed. Blocks may be square, rectangular, or have other types of shapes that can be tiled to completely fill a two-dimensional image. The dimensions of the blocks may vary, in different implementations and with different source images, and the block dimensions and shapes may vary within a single source image. Partitioning methods may attempt to partition an image in order to minimize intensity variation within blocks or may be constrained by other types of computed values for blocks. The portioning is applied to the derived images, as well, including the binary image and the contour images. Then, in the for-loop of steps 1906-1908, the contrast Cᵢ for each non-perimeter block i in the grayscale image is computed and stored. Perimeter and non-perimeter blocks are discussed, below, with reference to FIG. 20. In step 1910, a thresholding technique is used to generate a binary image from the grayscale image. A predetermined threshold may be used or, in certain implementations, the threshold may be computed based on the distribution of intensity values within the grayscale image. In one approach, a predetermined thresholding can be first used and then a second, refined threshold value may be computed based on the contrasts within the portions of the grayscale image corresponding to the white and black pixels in the initial binary image. In the for-loop of steps 1912-1915, the number of edges in each non-perimeter block of the binary grayscale image is computed by one of the edge-classification methods discussed above with reference to FIG. 18.

FIG. 20 illustrates selection of candidate blocks from a source image and binary source image for subsequent sharpness analysis. In FIG. 20, the left-hand rectangle 2002 represents the source image. The horizontal arrow 2004 represents candidate block selection. The right-hand outer rectangle 2006 again represents the source image and the cross-hatched regions 2008-2011 represent regions of the source image that contain selected candidate blocks for subsequent analysis. A first criteria 2012 for candidate blocks is that they do not occupy the perimeter of the source image, where the perimeter blocks are those blocks that reside in between the outer dashed line 2014 and the inner dashed line 2016 of the right-hand rectangle 2006 shown in FIG. 20. Perimeter blocks are prone to optical defects, including blurring and other types of distortion. The width of this perimeter region may be predetermined and contained as a value of a perimeter or input argument, or may be computed based on pixel-intensity and pixel-color characteristics and distributions. A second consideration 2018 is that candidate blocks should have a ratio of edge pixels to the total number of pixels in the block greater than a threshold value t₃. The number of edge pixels is selected from the binary version of the block. It should be noted that, as discussed above, the grayscale image is partitioned into blocks and that the dimensions, locations, and orientations of these blocks are used to partition both the source and binary images as well as the contour images into corresponding blocks. In alternative implementations, the source image may be partitioned, rather than the grayscale image. In other words, the blocks created in the initial partitioning represent the partitioning not only of the partitioned image, but the various images derived from or related to the partitioned image. As discussed above with reference to FIG. 18, edge pixels are selected from the total number of pixels in each block based on consideration of the binary values of neighboring pixels. A third criteria 2020 is that, in the binary version of blocks, a candidate block should have a ratio of the text-valued pixels to the total number of pixels less than a threshold t₄. In a normal document image, the text is dark and the background of text-containing regions is light. Thus, the binary value for text pixels is 0 in text-containing regions. However, in certain text documents, the characters are lightly colored against a darker background. In this case, in a binary block of a text-containing region, the binary value for text pixels is “1,” in case the two binary values are “0” and “1,” or “255” in the case that the two binary values are “0” and “255.” Thus, the third criterion 2020 specifies that the ratio of text pixels to total pixels in a block should be less than a threshold value, since in normal text-containing regions, the majority of pixels are background pixels. A final criterion 2022 is that the contrast for a candidate block in the source image should be greater than a threshold value t₅. Text-containing blocks of text-containing regions of the source image generally have relatively high contrast, with the text color and intensity generally quite different from the background color and intensity. The four criteria 2012, 2018, 2020, and 2022 for selection of candidate blocks for subsequent analysis are intended to select blocks from optically robust text-containing regions of the source and derived images.

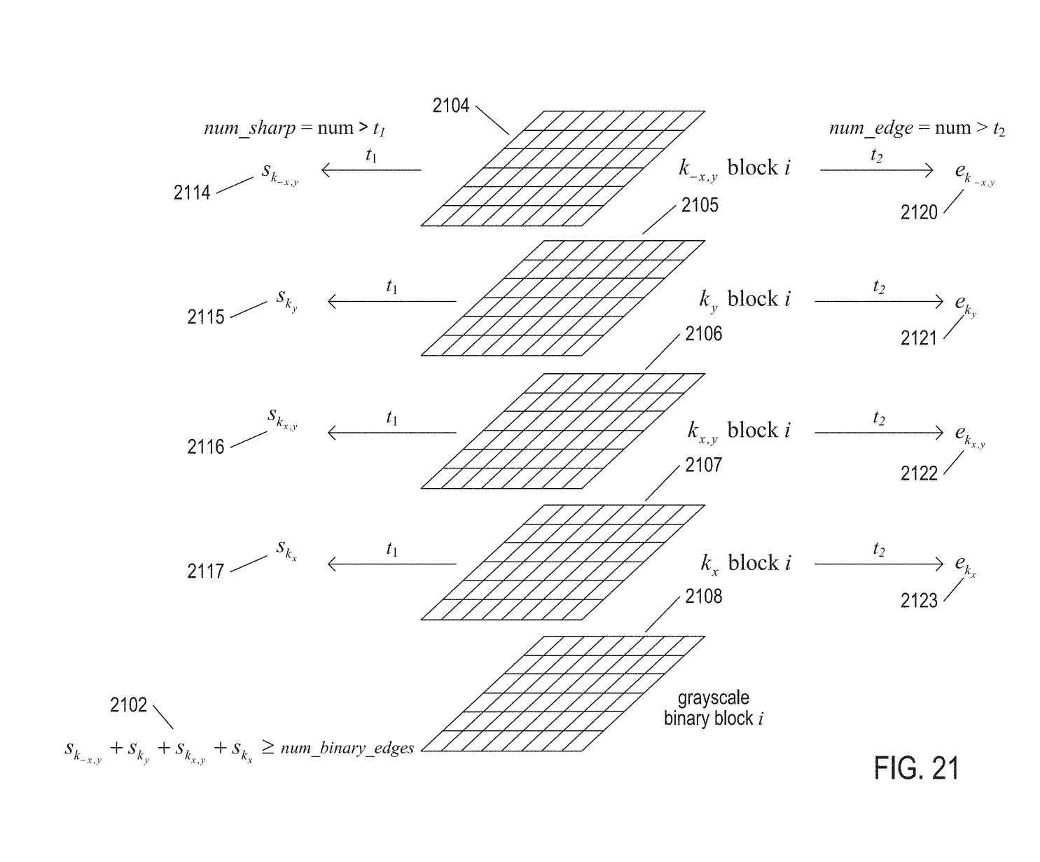

FIG. 21 illustrates determining of the number of sharp pixels, num_sharp, and the number of edge pixels, num_edge, in a block of the source image and derived images. To compute the number of sharp pixels, num_sharp, in a block, a first threshold t₁ is used. The number of pixels in a contour-image block with intensity values greater than the threshold value ti are considered to be sharp pixels. The threshold t₁ is selected by decreasing the threshold down from the value 255 until the sum of the number of sharp pixels in all of the contour-image blocks corresponding to the currently considered source-image block is greater than or equal to the number of edge pixels computed from the binary version of the source-image block 2102. Thus, in FIG. 21, a particular block, block i, of the source image is considered. The corresponding blocks of the four contour images 2104-2107 are depicted in a central column in FIG. 21, below which the corresponding grayscale binary block i 2108 is depicted. The number of edge pixels in grayscale binary block i 2108 is used to determine the value of the threshold t₁. A second threshold, t₂, is used to compute the number of edge pixels in each contour-image block 2104-2107. There are a variety of ways that the threshold t₂ can be computed. In one method, t₂ is assigned a value equal to a specified fraction of t₁. For example, one method for computing t₂ is:

t₂=w*t₁,

where w<1. Alternatively, t₂ may be computed as a multiple of a noise-dispersion constant σᵢ for the block i in the source image. The dispersion σᵢ for source-image block i may be determined by machine-learning methods or by histogram-based methods for estimating noise dispersion. As shown in FIG. 21, to compute the number of sharp pixels in a given block i, the number of sharp pixels in each corresponding contour-image block is computed by thresholding based on the threshold t₁. The number of sharp pixels in each of the contour-image blocks are then added together to produce the number of sharp pixels for block i. For example, in FIG. 21, the number of sharp pixels in each of the four contour blocks 2104-2107 are computed, by thresholding, as the values sₖ_{_{-x,y}} 2114, sₖ_{_{y}} 2115, sₖ_{_{x,y}} 2116, and sₖ_{ₓ} 2117. These values are then added together to produce the number of sharp pixels in block i. Similarly, thresholding with threshold t₂ is used, for each contour-image block 2104-2107 corresponding to block i to produce the number of edges in each of the corresponding contour-image blocks eₖ_{_{x,y}} 2120, eₖ_{_{y}} 2121, eₖ_{_{x,y}} 2122, and eₖ_{ₓ} 2123. These values are then added together to produce the number of edge pixels in the block. Then, a ratio of sharp pixels to edge pixels is computed as the number of sharp pixels in block i divided by the number of edge pixels in block i. Clearly, summation of the number of sharp pixels and the number of edge pixels computed by thresholding in the contour-image blocks corresponding to block i may over count the actual number of edge and sharp pixels, but it is only the ratio of the accumulated counts of sharp and edge pixels in the corresponding contour-image blocks that is computed and used for the analysis.

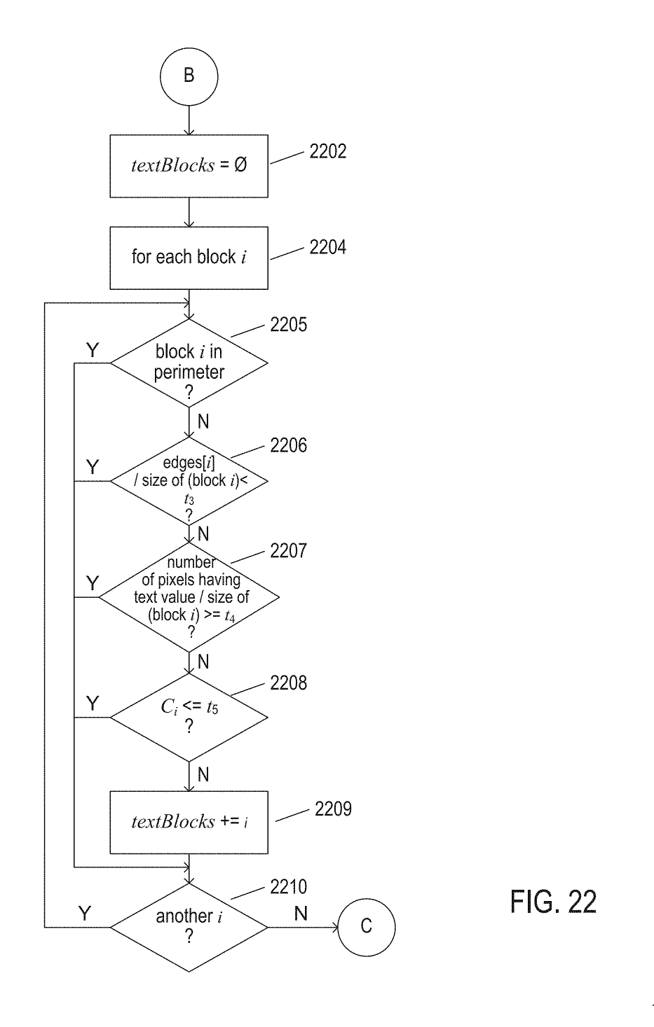

FIGS. 22-24 provide control-flow diagrams that complete the description and illustration of a first implementation of the preliminary-sharpness-analysis method disclosed in the current document. The control-flow diagram shown in FIG. 22 continues from the control-flow diagram shown in FIG. 19 via the letter-labeled-disk convention described above. In step 2202, a set variable textBlocks is set to the empty set. Then, in the for-loop of steps 2204-2210, candidate blocks are selected from the blocks of the grayscale image and added to the set variable textBlocks so that the set variable textBlocks, upon completion of the for-loop of steps 2204-2210, contains the candidate blocks selected via the criteria discussed above with reference to FIG. 20. Each block i in the grayscale image is considered in the for-loop of steps 2204-2210. When the currently considered block i is in the perimeter region of the grayscale image, as determined in step 2205, block i is not added to the set of candidate blocks textBlocks and control flows to step 2210. When the number of edge pixels, computed from the binary version of block i in the for-loop of steps 1912-1915 of FIG. 19, divided by the total number of pixels in block i is less than or equal to the threshold t₁, as determined in step 2206, block i is not added to the set of candidate blocks, and control flows to step 2210. When the number of pixels with the text value divided by the number of pixels in the block is greater than or equal to the threshold t₄, as determined in step 2207, block i is not added to the set of candidate blocks and control flows to step 2210. When the contrast Cᵢ of block i, computed from the source image, is less than or equal to threshold t₅, as determined in step 2208, block i is not added to the set of candidate blocks and control flows to step 2210. At step 2209, block i is added to the set of candidate blocks since block i has met all of the constraints discussed above with reference to FIG. 20 and represented by steps 2206-2208 in FIG. 22.

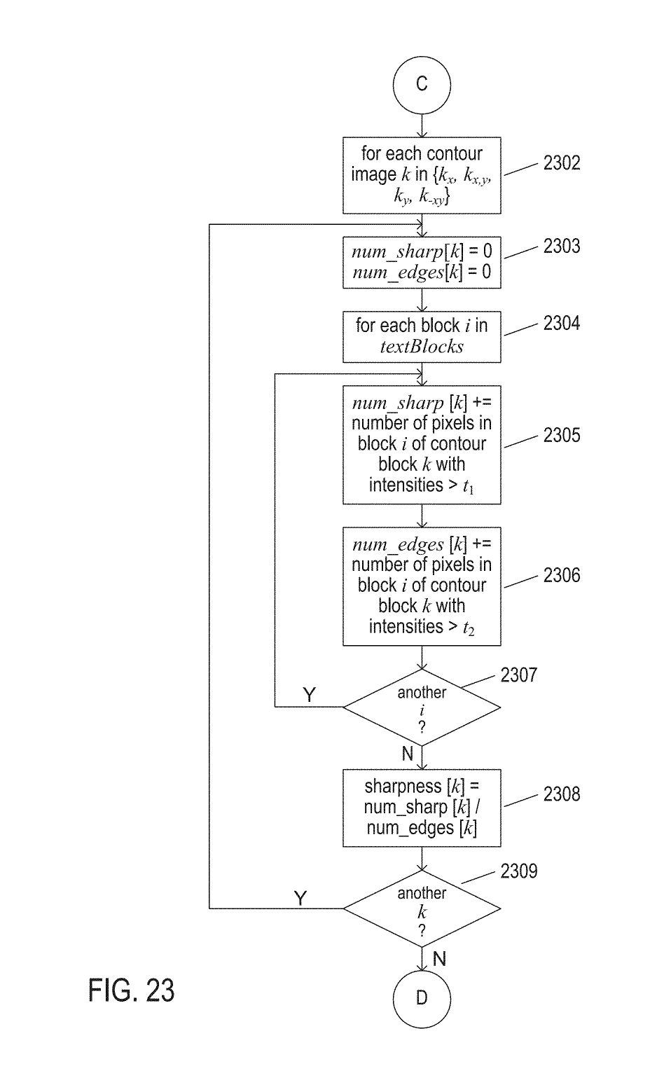

Turning to FIG. 23, which continues the control-flow diagram of FIG. 22, the ratio of the total number of sharp pixels to edge pixels for each of the four contour images kₓ, k_{x,y}, k_{y}, and k_{-x,y} is computed in the for-loop of steps 2302-2309. The for-loop of steps 2302-2309 considers, in an outer loop, each contour image kₓ, k_{x,y}, k_{y}, and k_{-x,y}. In step 2303, the number of sharp pixels and the number of edge pixels for the currently considered contour image k in the array num_sharp and the array num_edges are set to 0. Then, in the inner for-loop of steps 2304-2307, each block i of the candidate blocks contained in the set textBlocks is considered. In step 2305, thresholding with threshold t₁ is used to compute the number of sharp pixels in block i and add that number of sharp pixels to the number of sharp pixels for the currently considered contour image num_sharp[k]. In step 2306, the number of edge pixels in currently considered block i of contour image k is computed by thresholding with respect to threshold t₂ and added to the number of edge pixels for contour image k num_edges[k]. Once all of the candidate blocks have been processed in the inner for-loop of steps 2304-2307 for the currently considered contour image k, a sharpness value is computed for contour image k as the number of sharp pixels divided by the number of edge pixels for contour image k in step 2308, with the computed value stored in the array sharpness for contour image k.

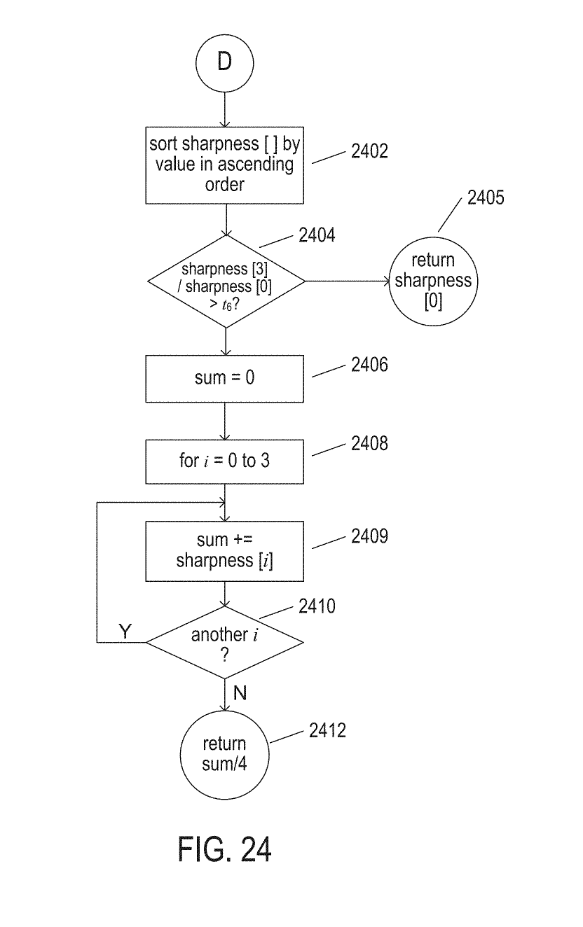

FIG. 24 provides the final control-flow diagram for the first implementation of the preliminary-sharpness-analysis method disclosed in the current document. In step 2402, the sharpness array that includes the computed sharpness for each of the contour images is sorted by value in ascending order. When the ratio of the maximum sharpness value to the minimum sharpness value is greater than a threshold t₆, as determined in step 2404, the minimum sharpness value for any of the contour images is returned, in step 2405, as the sharpness estimate for the source image. In this case, the image distortion is likely the result of motion-induced blur. Otherwise, in step 2406, the local variable sum is set to 0. Then, in the for-loop of steps 2408-2410, the sharpness values for the contour image are summed. Finally, the value stored in local variable sum is divided by the number of contour images, 4, and the result of the division returned as the sharpness estimate for the source image in step 2412. In this case, the image distortion is likely the result of a lack of focus.

The first implementation of the preliminary-sharpness-analysis method discussed in the current document is next summarized. A source digital image is input to the method. From this source digital image, a corresponding grayscale image and binary image are generated. In addition, four contour images are generated from the grayscale image by convolution with four differential-operator kernels. The source image is partitioned into blocks, and these same blocks are considered in all of the derived grayscale, binary, and contour images. In other words, a given block contains pixels with the same pixel indexes in all of the derived images as well as in the source image. Using the contrast computed for each block from the source image and the number of edge pixels in each block computed from the binary grayscale image, a set of candidate blocks is selected for subsequent analysis. The candidate blocks are used to determine the ratio of sharp pixels to edge pixels for each of the contour images. These ratios, referred to as “sharpness” values, are then used to select a final sharpness value for the source image. The final sharpness value is either the minimum sharpness value computed for any of the contour images or the average sharpness value of the four contour images.

Of course, the first implementation may have a variety of alternative implementations and variations. For example, any of the many threshold values discussed with respect to the control-flow diagrams provided in FIGS. 15, 19, and 22-24 may be alternatively computed or specified. Although four contour images are generated and used in the above-described implementation, fewer contour images or a greater number of contour images may be employed in alternative implementations. Variations in the computation of the various different computed values discussed with respect to the control-flow diagrams are possible, although the preliminary-sharpness-analysis method is intended to be computationally efficient in order to be executed in real time for a variety of different purposes, such as preliminary evaluation of images displayed in a view finder or LCD screen prior to image capture by mobile imaging devices. It is for this reason that small-sized kernels are used to derive contour images by convolution and also for edge-pixel determinations in which neighboring pixel intensity values are evaluated. Furthermore, slower and more complex arithmetic operations, including multiplication, division, squaring, and square-root operations, are minimized for computational efficiency.

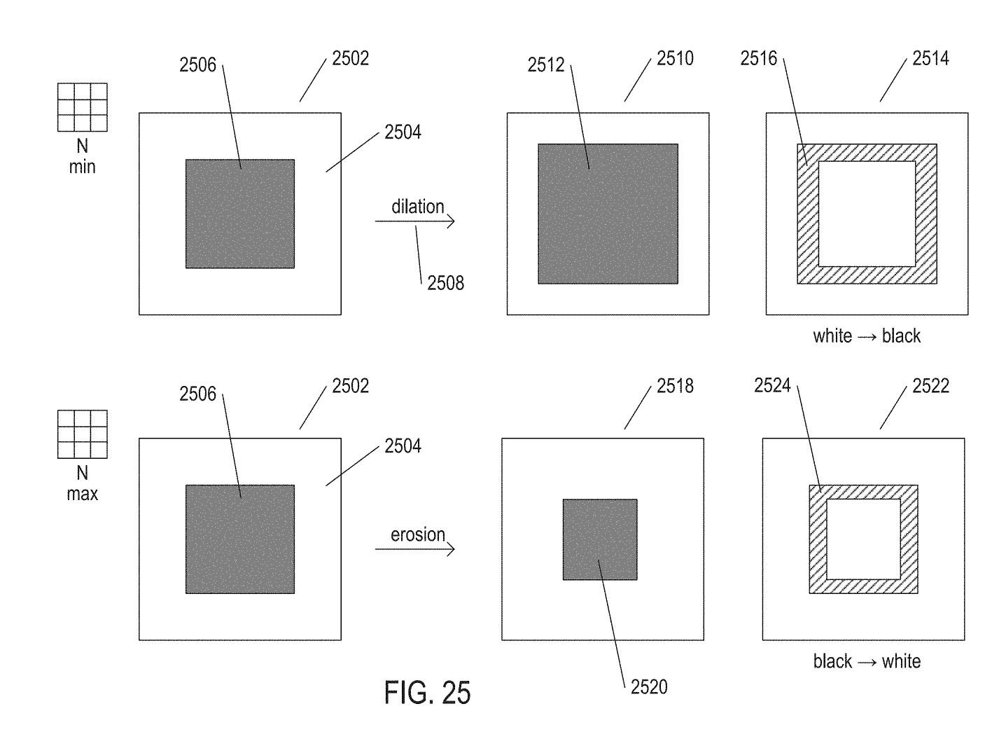

FIGS. 25-30 illustrate a second implementation of the preliminary-sharpness-analysis method disclosed in the current document. FIG. 25 illustrates the dilation and erosion operations carried out by convolution of 3×3 kernels or neighborhoods with a binary image. In the convolution, the kernel is superimposed over an image pixel and its neighborhood. In the case of dilation, the corresponding pixel in the dilated image is given the maximum value of any pixel underlying the kernel or neighborhood and, in the erosion operation, the corresponding pixel in the eroded image is given the minimal value of any pixel underlying the kernel or neighborhood. The effect of dilation is to generally increase the size of a darkly colored feature within a lighter background and the effect of erosion is to decrease the size of a darkly colored feature in a white background within a binary image. In FIG. 25, the binary image 2502 is a square image with a white background 2504 and a smaller, square, black feature 2506. The dilation operation 2508 produces a dilated image 2510 in which the size of the central black feature 2512 has increased. A third representation of the image 2514 indicates, with cross-hatching, the region of the image 2516 in which pixels that were originally white in the binary image 2502 have changed to black as a result of the dilation operation. Similarly, in the eroded image 2518, the central black feature has shrunk in size 2520. In a fourth representation of the image 2522, cross-hatching is used to illustrate the region 2524 of the eroded image that includes pixels that are now white that were originally black in the source binary image 2502. In the alternative implementation of the preliminary-sharpness-analysis method, one or both of dilation and erosion is employed to generate regions of pixels, such as regions 2516 and 2524 in FIG. 25, in which pixel values change as a result of the dilation and erosion operations. These pixels are pixels that were located at or near an intensity edge in the source image.

FIG. 26-30 provide control-flow diagrams that illustrate the alternative implementation of the preliminary-sharpness-analysis method disclosed in the current application. FIGS. 26-30 describe logic that replaces control-flow diagram 23 in the first-described implementation of the preliminary-sharpness-analysis method. In other words, substitution of FIGS. 26-30 for FIG. 23 produces the alternative implementation described by FIGS. 15, 19, 22, 26-30, and 24. In essence, the alternative implementation employs a different method for computing the sharpness value for each of the contour images.

Beginning with FIG. 26, in step 2602, a dilation operator, discussed above with reference to FIG. 25, is convolved with the binary image to generate a dilated image. In step 2604, an erosion operator is convolved with the binary image to generate an eroded image, as also discussed above with reference to FIG. 25. In step 2606, an edge-candidate filter is generated to select, as edge candidates, those pixels that changed values between the grayscale binary image and the dilated image and/or that changed value in the eroded image with respect to the grayscale binary image. In other words, returning to FIG. 25, the edge candidates are those pixels that lie in either or both of the regions 2516 and 2524 that represent values changes under dilation and erosion. In the for-loop of steps 2608-2610, all of the values in the num_sharp and num_edges arrays are set to 0.

Continuing to FIG. 27, in the outer for-loop of steps 2702-2710, each block in the set of candidate text-containing blocks contained in the set referenced by the set variable textBlocks, is considered. In step 2703, the edge-candidate filter generated in step 2606 of FIG. 26 is applied to obtain an initial set of candidates from the currently considered block i. Then, in the inner for-loop of steps 2704-2708, a set of sharp-pixel candidates and a set of edge-pixel candidates is generated for each of the corresponding blocks i in the contour images. In step 2705, a logical histogram for the pixel values in the currently considered contour-image block is generated for pixels in the currently considered contour-image block corresponding to the initial candidates generated in step 2703. Pixels with intensities less than a threshold value are discarded from consideration. In step 2706, a set of sharp-pixel candidates for the currently considered contour block, referred to as “k_sharp_candidates,” is selected from the pixels remaining after step 2705 by thresholding with respect to the threshold ti. Similarly, in step 2707, set of sharp-pixel candidates for the currently considered contour block are selected by thresholding with respect to threshold t₂ of the pixels remaining after step 2705. After the completion of the inner for-loop of steps 2705-2708, a set of sharp candidates and edge candidates for each of the blocks corresponding to the currently considered block i in each of the contour images has been prepared. Then, in step 2709, the routine “sharp and edge” is called to process the sets of candidate pixels generated in the inner for-loop of steps 2704-2708.

FIG. 28 provides a control-flow diagram for the routine “sharp and edge” called in step 2709 of FIG. 27. In the outer for-loop of steps 2802-2812, each pixel in the set of initial candidates generated in step 2703 of FIG. 27 is considered. In step 2803, all of the values in two arrays sharp and edge are set to 0. Then, in the inner for-loop of steps 2804-2810, the currently considered pixel is evaluated in each of the contour-image blocks containing the pixel. When the currently considered pixel is not the maximum-valued pixel in its neighborhood within the currently considered contour-image block, as determined in step 2805, the pixel is not further considered, and control flows to step 2810 to decided wither to continue with a next iteration of the inner for-loop of steps 2804-2810. When the currently considered pixel is a member of the sharp-pixel candidates for the currently considered contour image, as determined in step 2806, the pixel value is placed in an element of the array sharp for the currently considered contour image in step 2807 and, when the currently considered pixels in the set of edge candidates for the currently considered contour-image block, as determined in step 2808, the value of the pixel is placed into the element of the array edge corresponding to the currently considered contour image. Thus, in the for-loop of steps 2804-2810, only when the currently considered pixel is the maximum-value pixel in its neighborhood within a contour-image block containing the pixel is the pixel considered as a potential sharp pixel or edge pixel. In step 2811, the routine “update” is called.

FIG. 29 provides a control-flow diagram for the routine “update,” called in step 2811 of FIG. 28. In step 2902, the local variables best_sharp, top_sharp, best_edge, and top_edge are set to the value −1. Then, in the for-loop of steps 2904-2913, the value of the currently considered pixel in the four contour blocks is evaluated to select the contour block, in any, for which the pixel is the highest valued sharp pixel and the contour block, if any, for which the pixel is the highest valued edge pixel. The number of sharp pixels for the contour image that contains the selected contour block for which the pixel is the highest valued sharp pixel is updated in step 2911 and the number of edge pixels for the contour image that contains the selected contour block for which the pixel is the highest valued edge pixel is updated in step 2913. In other words, each pixel can only contribute to the aggregate number of sharp pixels for one contour-image block and can only contribute to the aggregate number of edge pixels for one contour-image block. In step 2905, when the value of the currently considered pixel in the currently considered contour-image block is greater than the value stored in local variable best_sharp, as determined in step 2905, the local variable best_sharp is updated to the value of the currently considered pixel in the currently considered contour-image block and the value of the local variable top_sharp is set to the currently considered contour image. In step 2907, when the value of the currently considered pixel in the currently considered contour-image block is greater than the value stored in local variable best_edge, as determined in step 2907, then the local variable best_edge is set to the value of the currently considered pixel in the currently considered contour-image block and the local variable top_edge is set to the currently considered contour image in step 2908. Following completion of the for-loop of steps 2904-2909, when the value in the local variable top_sharp is not equal to −1, as determined in step 2910, the number of sharp pixels for the contour image indicated by the current value of top_sharp is incremented in step 2911. In step 2912, when the value stored in the local variable top_edge is not equal to −1, then, in step 2913, the number of edge pixels for the contour image indicated by the current value of the local variable top_edge is incremented.

FIG. 30 provides a control-flow diagram that continues the control-diagram shown in FIG. 26. The control-flow diagram shown in FIG. 30 comprises a single for-loop of steps 3002-3004 in which the sharpness-metric values for each of the contour images is computed as the ratio of the number of sharp pixels in the contour image divided by the number of edges in the contour image. This computation of sharpness-metric values for each of the contour images prepares for the final determination of a sharpness value for the source image in FIG. 24, discussed above.

To summarize, the alternate implementation, discussed above with reference to FIGS. 25-30, employs a different method for computing sharpness-metric values for the contour images. In this method, in each block of the image and contour images, an initial set of candidate pixels is selected as those pixels that change value under dilation and erosion of the corresponding binary-image block. These initial candidate pixels are then evaluated in each of the contour-image blocks corresponding to the source image block containing the candidate pixel. The candidate pixel must have the highest value in its neighborhood within a contour image to be considered as a sharp pixel or an edge pixel in the contour image. Furthermore, at most only one contour image is updated based on the value of the pixel with respect to the number of sharp pixels and only one contour image is updated based on the value of the pixel with respect to the number of edge pixels.

As with the first implementation, there are many possible variations of the second implementation, including the type of operators used for dilation and erosion and the size of the neighborhood used to evaluate whether a pixel is maximally valued in the neighborhood within a contour image.

FIG. 31 provides a high-level architectural diagram of a computer system, such as a computer system in which the currently disclosed preliminary-sharpness-analysis method is employed to obtain a suitability metric for subsequent image processing. Mobile imaging devices, including smart phones and digital cameras, can be similarly diagramed and also include processors, memory, and internal busses. Those familiar with modern technology and science well appreciate that a control program or control routine comprising computer instructions stored in a physical memory within a processor-controlled device constitute the control component for the device and are as physical, tangible, and important as any other component of an electromechanical device, including image-capturing devices. The computer system contains one or multiple central processing units (“CPUs”) 3102-3105, one or more electronic memories 3108 interconnected with the CPUs by a CPU/memory-subsystem bus 3110 or multiple busses, a first bridge 3112 that interconnects the CPU/memory-subsystem bus 3110 with additional busses 3114 and 3116, or other types of high-speed interconnection media, including multiple, high-speed serial interconnects. These busses or serial interconnections, in turn, connect the CPUs and memory with specialized processors, such as a graphics processor 3118, and with one or more additional bridges 3120, which are interconnected with high-speed serial links or with multiple controllers 3122-3127, such as controller 3127, that provide access to various different types of mass-storage devices 3128, electronic displays, input devices, and other such components, subcomponents, and computational resources.

In a variety of different types of systems, including image-processing systems, the sharpness value produced by the above-described implementations of the preliminary-sharpness-analysis method can be used to compute an estimated level of accuracy or estimated level of inaccuracy for image processing of the image associated with the computed sharpness value. The sharpness value, along with additional intermediate values computed by the preliminary-sharpness-analysis method, may be input to various different types of classifiers, such as random-forest classifiers, to determine an estimated accuracy or inaccuracy for image processing or may be input to a trained regressor that is trained based on a database of photographed documents of various types, along with actual accuracies or inaccuracies obtained when the imaging processes were applied to them. In certain implementations, input to the classifier or trained regressor includes the sharpness values for each of the contour images, a computed contrast, the number of text blocks, the ratio of text-value pixels to total pixels in the binary image, and other such computed values. Additional information may be submitted to the classifier or regressor with regard to statistics regarding the size of text-symbol features in the text-containing portions of the document and other statistics computed from recognized symbols.

Although the present invention has been described in terms of particular embodiments, it is not intended that the invention be limited to these embodiments. Modifications within the spirit of the invention will be apparent to those skilled in the art. For example, any of many different design and implementation parameters, including modular organization, programming language, hardware platform, control structures, data structures, and other such design and implementation parameters, may be varied to provide a variety of different implementations of the disclosed preliminary-sharpness-analysis method.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system that evaluates a source image for suitability for application of image processing, the system comprising:
one or more processors;
one or more electronic memories; and
computer instructions, stored in the one or more of the one or more electronic memories that, when executed by one or more of the one or more processors, control the system to:
receive the source image,
generate, from the received source image, derived images, including contour images that each represents directional components of estimated intensity gradients,
store, in one or more of the one or more electronic memories, the derived images,
generate, from directional-component values in the contour images that are each associated with a different pixel of the source image, a sharpness-metric value for each contour image,
generate, from the sharpness-metric values generated for each contour image, a sharpness-metric value for the source image, and
store the generated sharpness-metric value for the source image in one or more of the one or more electronic memories.

2. The system of claim 1 wherein each of the contour images are generated from a grayscale image corresponding to the source image by convolving the grayscale image with a differential-operator kernel.

3. The system of claim 2 wherein four differential operators are used to generate four contour images that represent the directional components of the estimated intensity gradients in the i, j, i+j, and −i+j directions, where i and j are unit vectors in the directions of the coordinate axes of the source image.

4. The system of claim 1 wherein the sharpness-metric value is generated for each contour image by:
determining a set of candidate pixels;
determining, based on the values associated with each candidate pixel in the contour images, whether or not each candidate pixel is a sharp pixel and whether or not each candidate pixel is an edge pixel; and
using the determinations of whether or not each of the candidate pixels is a sharp pixel and whether or not each candidate pixels is an edge pixel to generate a sharpness-metric value for each contour image.

5. The system of claim 4 wherein the derived images include:
a grayscale image in which a value associated with each pixel represents the intensity component of the pixel in the source image; and
a binary image in which one of two values, including a first binary value and a second binary value, is associated with each pixels, each value obtained by applying a threshold intensity to the intensity value associated with the corresponding pixel in the grayscale image.

6. The system of claim 5 wherein determining a set of candidate pixels further includes:
partitioning the source image and derived images into blocks, using the same partitioning for the source image and derived images;
selecting, as a first set of blocks, blocks outside of a perimeter portion of the source and derived images;
for each block i in the first set of blocks,
determining a contrast Cᵢ for block i, and
determining a number of edge pixels Eᵢ in block i; and
selecting, as the set of candidate pixels, the pixels in each block i in the first set of blocks for which
a ratio of edge pixels Eᵢ to a number of pixels in block i is greater than a first threshold value,
a ratio of a number of pixels in binary-image block i associated with a binary value corresponding to a binary value characteristic of text to the number of pixels in block i is less than a second threshold value, and
the contrast Cᵢ for block i is greater than a third threshold.

7. The system of claim 6 wherein determining a contrast Cᵢ for block i comprises:
sorting the values of the pixels of block i in the grayscale image;
generating a set of remaining pixels by selecting those pixels of block i with associated intensity values greater than a fourth threshold value and less than a fifth threshold value; and
determining, as the contrast Cᵢ, the difference between the maximal and minimal intensity values associated the pixels of the set of remaining pixels in the grayscale image.

8. The system of claim 6 wherein determining the number of edge pixels Eᵢ in block i comprises:
determining, for each pixel p in block i, whether pixel p is at or near an intensity edge by considering pixels in the neighborhood of pixel p in the binary image; and
determining the number of edge pixels Eᵢ in block i as the number of pixels for which the neighborhood of the pixel includes an intensity edge.

9. The system of claim 4 wherein determining, based on the values associated with each candidate pixel in the contour images, whether or not each candidate pixel is a sharp pixel and whether or not each candidate pixel is an edge pixel, further comprises:
for each contour image k,
for each block i containing a candidate pixel,
for each candidate pixel p in block i,
determining whether pixel p is a sharp pixel in contour image k by determining whether the value associated with pixel p in block i of contour image k is greater than a threshold value for sharp pixels in block i, and
determining whether pixel p is an edge pixel in contour image k by determining whether the value associated with pixel p in block i of contour image k is greater than a threshold value for edge pixels in block i.

10. The system of claim 9 wherein using the determinations of whether or not each of the candidate pixels is a sharp pixel and whether or not each candidate pixels is an edge pixel to generate a sharpness-metric value for each contour image further comprises:
for each contour image k,
dividing the number of candidate pixels in contour image k determined to be sharp pixels by the number of candidate pixels in contour image k determined to be edge pixels to generate the sharpness-metric value for contour image k.

11. The system of claim 4 wherein determining, based on the values associated with each candidate pixel in the contour images, whether or not each candidate pixel is a sharp pixel and whether or not each candidate pixel is an edge pixel, further comprises:
applying a dilation-operator kernel to pixels in the grayscale image to generate a dilated image;
applying an erosion-operator kernel to pixels in the grayscale image to generate an eroded image;
refining the set of candidate pixels to include those candidate pixels for which the binary value associated with the pixel in one of the dilated image and the eroded image is different from the binary value associated with the pixel in the grayscale image;
for each contour image k,
for each block i,
for each pixel p in block i of contour image k having a value greater than a threshold value for block i of contour image k,
determining whether pixel p is a sharp pixel in contour image k by determining whether the value associated with pixel p in block i of contour image k is greater than a threshold value for sharp pixels in block i, and
determining whether pixel p is an edge pixel in contour image k by determining whether the value associated with pixel p in block i of contour image k is greater than a threshold value for edge pixels in block i.

12. The system of claim 11 wherein determining, based on the values associated with each candidate pixel in the contour images, whether or not each candidate pixel is a sharp pixel and whether or not each candidate pixel is an edge pixel, further comprises further comprises:
for each contour image k,
setting a count of sharp pixels for contour image k to 0,
setting a count of edge pixels for contour image k to 0,
for each sharp pixel in contour image k
when the sharp pixel has a maximum value within a neighborhood of pixels in contour image k and when the sharp pixel has a maximum value with respect the values of the pixel in all contour images, incrementing the count of sharp pixels for contour image k, and
for each edge pixel in contour image k
when the edge pixel has a maximum value within a neighborhood of pixels in contour image k and when the edge pixel has a maximum value with respect the values of the pixel in all contour images, incrementing the count of edge pixels for contour image k.

13. The system of claim 12 wherein using the determinations of whether or not each of the candidate pixels is a sharp pixel and whether or not each candidate pixels is an edge pixel to generate a sharpness-metric value for each contour image further comprises:
for each contour image k,
dividing the count of sharp pixels for contour image k by the count of edge pixels for contour image k to generate the sharpness-metric value for contour image k.

14. The system of claim 1 wherein the sharpness-metric value for the source image is generated from the sharpness-metric values generated for each contour image by:
when the ratio of the maximum sharpness-metric value for a contour image to the minimum sharpness-metric value for a contour image is greater than a sharpness-metric-value-ratio threshold, selecting the minimum sharpness-metric value for a contour image as the sharpness-metric value for the source image; and
otherwise computing an average of the sharpness-metric value for the contour images as the sharpness-metric value for the source image.

15. The system of claim 1 included in a mobile imaging device to evaluate a viewfinder image to determine whether or not to capture a full image corresponding to the viewfinder image and store the store the captured image in electronic memory for subsequent image processing.

16. The system of claim 1 included is an image-processing system to determine whether or not to apply computational image processing to input digital images.

17. The system of claim 15 wherein image processing includes optical character recognition.

18. A method that evaluates a source image for suitability for application of image processing in a system or subsystem including one or more processors and one or more electronic memories, the method comprising:
receiving the source image,
generating, from the received source image, derived images, including contour images that each represents directional components of estimated intensity gradients,
storing, in one or more of the one or more electronic memories, the derived images,
generating, from directional-component values in the in the contour images that are each associated with a different pixel of the source image, a sharpness-metric value for each contour image,
generating, from the sharpness-metric values generated for each contour image, a sharpness-metric value for the source image, and
storing the generated sharpness-metric value for the source image in one or more of the one or more electronic memories.

19. The method of claim 18
wherein each of the contour images is generated from a grayscale image corresponding to the source image by convolving the grayscale image with a differential-operator kernel; and
wherein four differential operators are used to generate four contour images that represent the directional components of the estimated intensity gradients in the i, j, i+j, and −i+j directions, where i and j are unit vectors in the directions of the coordinate axes of the source image.

20. The method of claim 18 wherein the sharpness-metric value is generated for each contour image by:
determining a set of candidate pixels;
determining, based on the values associated with each candidate pixel in the contour images, whether or not each candidate pixel is a sharp pixel and whether or not each candidate pixel is an edge pixel; and
using the determinations of whether or not each of the candidate pixels is a sharp pixel and whether or not each candidate pixels is an edge pixel to generate a sharpness-metric value for each contour image.

21. A physical data-storage device that stores computer instructions that, when executed by one or more processors of a system including one or more processors and one or more electronic memories, controls the system to:
receive a source image;
generate, from the received source image, derived images, including contour images that each represents directional components of estimated intensity gradients;
store, in one or more of the one or more electronic memories, the derived images;
generate, from directional-component values in the in the contour images that are each associated with a different pixel of the source image, a sharpness-metric value for each contour image;
generate, from the sharpness-metric values generated for each contour image, a sharpness-metric value for the source image; and
store the generated sharpness-metric value for the source image in one or more of the one or more electronic memories.
